(19) United States
(12) Patent Application Publication
(10) Pub. No.: US 2009/0027698 A1
(43) Pub. Date: Jan. 29, 2009

(54) Device and Method for Processing Sheets, Particularly for Printing

(76) Inventors: Eli Velner, RaAnana (IL); Adam Rubinstein, Nehora (IL)

Correspondence Address: MARTIN D. MOYNIHAN d/b/a PRTSI, INC., P.O. BOX 16446, ARLINGTON, VA, 22215, US

(21) Appl. No.: 12/224,173

(22) PCT Filed: Oct. 18, 2006
(86) PCT No.: PCT/IL2006/001201

§ 371 Date: Aug. 20, 2008

Related U.S. Application Data
(60) Provisional application No. 60/776,418, filed on Feb. 24, 2006.

(51) Int. Cl. G06F 3/12

(52) U.S. Cl. 358/1.1

(57) ABSTRACT

A processing device for processing at least one curved passing sheet. The processing device comprises a processing assembly for applying processing to one or more passing sheets, and a feed assembly for passing the sheets by the processing assembly via a non-linear path.

### FIELD AND BACKGROUND OF THE INVENTION

The present invention relates to a sheet processing device such as a printer and, more particularly but not exclusively, to a portable cylindrical sheet processing device for printing, scanning or copying images.

Microelectronic manufacturing techniques have led to the miniaturization of numerous devices. Mobile phones, personal digital assistant devices, and digital cameras are very common examples of the miniaturization trend.

However, not all devices and systems may be miniaturized to any requested size. Most devices and systems have one or more physical limitations which determine their possible minimal sizes. For example, some physical features of such devices or systems cannot be miniaturized without substantially reducing the efficiency of the devices or the systems. One group of devices that has substantial limitations is the sheet processing group. The sheet processing group comprises devices such as printers, scanners, facsimiles, and combinations thereof. The main limitation of each of these devices is the size of the sheet which can be processed. It may be assumed that, with each known device, the width of the sheet directly determines the width of the sheet processing device.

In each of the known inkjet printers, for example, a belt is stretched along a feeding path which extends along the printer. The belt is used to attach a printhead assembly to a motor which is used to set the printhead in motion. The belt, in combination with a sheet feeding mechanism, allows the printhead to print anywhere along the sheet. In use, the sheet is conveyed via the feeding path and a motor is used to maneuver the printhead assembly along the sheet in a straight line. Accordingly, in order to allow the printhead to print anywhere on the sheet, the width of the printer belt and feeding path has to correspond to the width of the sheet. Moreover, it should be noted that the printhead is usually fixated to a shaft which is placed parallelly to the width of the fed sheet. The shaft is used in order to assure that printhead is maneuvered across the width of the fed sheet in a stable manner. Additionally, the shaft length has to extend beyond the width of the fed sheet in order to allow the positioning of the printhead above the edges of the fed sheet. Clearly, the width of the printer is wider than the length of the shaft in order to enclose all the printer components.

For example, since the most commonly used sheets are letter-sized paper sheets, the widths of the majority of the printers have to correspond thereto. Commonly used letter-sized paper sheets are A4 pages which are 210 millimeters wide and 297 millimeters long in Europe and in most locations outside of the U.S., and which are 216 millimeters wide and 279 millimeters long in the U.S.

Since the width of a printer has to correspond to the width of the sheet, the fact that other features of the printer may be minimized cannot allow the production of a compact printing device having a width which is less than the width of the sheet printed. A compact printer having a limited width may be used to print on a sheet having an equivalent width but cannot be used for printing on a letter-sized paper sheet.

For example, U.S. Pat. No. 6,924,907, issued on Aug. 2, 2005, discloses a printing module for a compact printer system comprising a stationary printhead, an ink reservoir, a motive means and an image storing means, all housed within an elongate body. The motive means carries a sheet past the printhead which prints a full width image in a single pass. A power supply is also preferably housed within the elongate body. The body is preferably cylindrical and is approximately the size of a large pen. The printhead is suitably a monolithic drop-on-demand inkjet printer. Although the patent describes a compact printer system, the width of the disclosed printing module depends on the width of the sheet used, as discussed above. Accordingly, if the sheet is letter-sized, the width of the printer system has to be wider than 216 millimeters, approximately 300 millimeters. If, however, the sheet is a business card, the width of the printing module has to be wider than 95.25 millimeter. Hence, although the patent discloses a compact-sized printing device, the width of such a printer for letter-sized paper sheets is still significant since it is wider than the printed media itself. The width of such a printer does not allow a user to carry the printer in his pocket or in a limited space such as a narrow bag.

The width limitation exists in all known printers. For example, U.S. Pat. No. 7,002,611, issued on Feb. 21, 2006, discloses a thermal printer, including a drive platen, wherein the external dimensions have been reduced so that the device is suitable for use with a portable information apparatus. The thermal printer includes a thermal head, a platen cooperating with the thermal head to maintain a printing sheet between the platen and the thermal head, an elastic member pressing the thermal head and the platen together, a frame carrying the thermal head in a fixed manner and the platen in a movable manner relative to the thermal head, and a drive mechanism driving the platen. The drive mechanism includes a rotational drive source; a gear unit for transmitting torque from the rotational drive source to the platen; and a pivot member capable of pivoting about the axis of a gear, arranged in front of the platen in the gearing unit, together with the platen and following gears arranged behind the prior or former gear. However, as described above, the width of the thermal printer directly corresponds to the width of the designated sheet.

Clearly, the aforementioned width limitations exist in other sheet processing devices such as facsimile machines, optical scanners, and multifunction devices that combine printers with a scanner or a facsimile. Moreover, since the printhead is conveyed, accelerated, and decelerated across a linear feeding path in front of fed sheet, in parallel to the sheet promotion, the power consumption of the printer is relatively high. In Inkjet printers, for example, the requirement to convey the printer head in an accurate manner in a relatively high velocity obliges the fixation of the printhead to relatively massive shaft, as described above. This requirement effects the printer weight and power consumption. Such requirements particularly limit the performances and the sizes of miniature printers, which are designed to be compact and powered by batteries.

It should be noted that the weight, power supply, and complexity of the sheet processing device are affected by the width of the device. The wider the sheet used, the wider must be the sheet feeder and the printhead track. Also, the wider the sheet, the greater is the total weight of the printer. Moreover, the power supply which is needed to move the printhead during printing process is relatively high. The variable accelerations and frequent changes in the placing of the printhead require relatively high power consumption. In mobile printers, such demand for power supply found expression in the requirement for large and heavy batteries. There is thus a widely recognized need for, and it would be highly advantageous to have, a portable and narrow sheet processing device devoid of the above limitations.

### SUMMARY OF THE INVENTION

According to one aspect of the present invention there is provided a processing device for processing one or more curved passing sheet. The processing device comprises a processing assembly for applying processing to the curved passing sheets; and a feed assembly for passing the curved passing sheets by the processing assembly via a non-linear path, along a first vector substantially parallel to a second vector around which the curved passing sheet is curved.

Preferably, the non-linear path is approximately annular.

Preferably, the non-linear path is approximately a semi circle.

Preferably, the assembly is configured to feed the at least one curved passing sheet separately widthwise and lengthwise about the processing assembly to allow linear processing of the at least one curved passing sheet about the processing assembly.

Preferably, the feed assembly is an annular sheet feeding mechanism for wrapping the at least one curved passing sheet about the processing assembly.

Preferably, the processing assembly is stationary.

Preferably, feed assembly is a mechanic transmission configured for conveying the at least one curved passing sheet via a non-linear path in a manner that facilitates the shifting of the entire inner surface area of the at least one curved passing sheet in front of the processing assembly.

More preferably, the mechanic transmission comprises at least one of the following group: a gearbox, a set of gears and levers, a set of bands and wheels, an hydraulic system, and a system which is used for transmitting mechanical power from one or more prime movers to a mechanical power output device.

Preferably, the feed assembly is configured to feed the at least one curved passing sheet in rotary and linear directions about the processing assembly to allow linear processing of the at least one curved passing sheet about the processing assembly.

Preferably, the feed assembly is configured to feed the at least one curved passing sheet in a linear direction about the processing assembly, the processing assembly is configured to be rotated to allow processing of the at least one curved passing sheet.

Preferably, the processing device further comprises an internal assembly having an external side and an external cylindrical housing having an internal side. The non-linear path is formed by positioning the internal side relative to the external side of the internal assembly to form an annular feeding path therebetween, wherein the external cylindrical housing and the internal assembly are concentric.

Preferably, the feed assembly comprises a magnetic stabilization mechanism for controlling the rotational positioning of the internal assembly.

More preferably, the magnetic stabilization mechanism comprises one or more pairs that comprise an internal magnetic component having a first attraction site disposed toward the annular feeding path, the internal magnetic component is coupled to the internal assembly. Each pair further comprises an external magnetic component having a second attraction site disposed toward the annular feeding path, the external magnetic component is coupled to the external cylindrical housing;

wherein the first and second attraction sites having at least one inverted poles.

More preferably, at least one of the external and internal magnetic components is connected to an electric source.

Preferably, the feeding is done in a helical manner.

Preferably, the processing assembly comprises a printing module.

More preferably, the printing module comprises a series of nozzles are configured to spray drops of ink.

More preferably, the printing module comprises a thermo-printing head.

More preferably, the processing assembly comprises an ink repository adapted to communicate with the printing module.

More preferably, the printing module comprises an ink cartridge dispenser configured to house and to control at least one ink cartridge.

More preferably, the printing module comprises a printhead dispenser configured to house and to control at least one replaceable printhead having an integrated ink repository.

More preferably, the processing device further comprises a storage device for storing an image to be printed by the printing module.

Preferably, the processing assembly comprises a scanning module.

More preferably, the scanning module comprises a contact image sensor (CIS) and at least one light source.

Preferably, the processing device further comprises a communication interface.

More preferably, the communication interface is used for receiving at least one transmission image from at least one computing unit, the at least one transmission image comprising at least one coded image, the at least one curved passing sheet is processed by the processing unit according to the at least one coded image.

More preferably, the communication interface is used for receiving operation instructions from a computing unit.

More preferably, the communication interface comprises a modem with facsimile signaling.

More preferably, the communication interface comprises a cellular transceiver, the communication interface is used for receiving at least one of the following transmissions: a Short Message Service (SMS) transmission, and a Multimedia Messaging Service (MMS) transmission.

More preferably, the communication interface is used to generate a transmission of at least one coded image of the at least one curved passing sheet.

More preferably, the communication interface is used for one or both of transmitting and receiving a facsimile transmission.

More preferably, the communication interface comprises at least one of the following connections: an RS-232 connection, an Ethernet connection, an Universal Serial Bus (USB) connection, a Firewire connection, an USB2 connection, a CompactFlash™ card drive, a SmartMedia™ card drive, a Memory Stick™ card drive, a Secure Digital™ card drive, a miniSD™ card drive, and a MicroSD™ card drive.

More preferably, the communication interface comprises at least one of the following transceivers: a cellular transceiver, a Radio Frequency (RF) transceiver, and an Infrared (IR) transceiver.

Preferably, the processing device further comprises an external feeder, the external feeder is configured to align the at least one curved passing sheet in a manner that facilitates feeding via the non-linear path.

Preferably, the processing device further comprises a man/machine interface (MMI) for enabling users to have the ability to input operational instructions.

More preferably, the MMI comprises a screen display.

More preferably, the screen display is adapted to display at least one coded image of the at least one curved passing sheet.

Preferably, the feed assembly comprises a sheet conveyer for conveying at least one curved passing sheet through non-linear path.

More preferably, the processing device further comprises at least one clip configured to hold the sheet conveyer in a compressed configuration.

More preferably, the processing device further comprises an extraction mechanism for extracting one of the at least one curved passing sheet from the non-linear path.

More preferably, the sheet conveyer has a springlike shape.

More preferably, the feed assembly comprises at least one motor and a lever.

More preferably, the lever is configured on one side to be connected to the at least one motor, and configured on the other side to be disposed within a slit which extends along the sheet conveyer.

Preferably, the feed assembly comprises a set of gear wheels for controlling the rotational positioning of the internal assembly during the processing.

More preferably, the mechanic transmission comprises a first annular set of wheels configured to be coupled to an internal rounded base and a second annular set of wheels configured to be coupled to an internal rotating annulus, the internal rotating annulus having an axis of rotation and configured to be concentrically positioned in between the internal rounded base and the external cylindrical housing. The axes of the first annular set of wheels define a plane that is nearly perpendicularly positioned with respect to the axis of rotation of the internal rotating annulus.

Preferably, the processing device further comprises a storage unit for storing coded images of the at least one curved passing sheet.

Preferably, the processing device further comprises an audio module configured for allowing users to listen to audio files.

Preferably, the processing device further comprises at least one of the following group: a cellular telephone, and a cellular modem.

More preferably, the storage unit is adapted to store audio files, the processing device further comprising an audio unit having an audio output, the audio output is configured to output audio signals based on the audio files.

Preferably, the at least one curved passing sheet is chosen from the following group: transparency sheets, photo paper sheets, paper sheets, cardboard sheets, technical drawing sheets, poster sheets, flip chart sheets, large table sheets, note pad sheets, and letter-sized paper sheets.

Preferably, the processing device is configured to be connected with a tripod.

According to another aspect of the present invention there is provided a processing device for processing one or more passing sheet. The processing device comprises a stationary processing assembly for applying processing to a printing area, the printing area having dimensions defined by length and width substantially smaller than the length and width dimensions of the at least one passing sheet, and a feed assembly for feeding the one or more sheets separately widthwise and lengthwise about the printing area to allow processing of approximately all the surface area of the one or more sheets.

According to another aspect of the present invention there is provided a cylindrical processing device for processing one or more sheets. The cylindrical processing device comprises an internal assembly having an external side, an external cylindrical housing having an internal side, the internal side is positioned relative to the external side of the internal assembly so as to form an annular feeding path therebetween, wherein the external cylindrical housing and the internal assembly are concentric, a processing assembly adapted to be positioned adjacent to the annular feeding path, and a feed assembly for feeding the one or more sheets through the annular feeding path.

According to another aspect of the present invention there is provided a method for processing one or more sheets using a device having a non-linear feeding path and a processing unit. The method comprises several steps:
a) Curving one or more sheets.
b) Conveying the one or more sheets through the non-linear feeding path, along a first vector substantially parallel to a second vector around which the one or more sheets are curved.
c) Using the processing unit for processing one of the one or more sheets during the conveying.

Preferably, the step (c) comprises using the processing unit for printing on the one of the one or more sheets.

Preferably, the method further comprises a step between step (a) and step (b) of receiving at least one coded image from a separate computing unit, the printing is done according to the at least one coded image.

More preferably, the receiving is done using a modem with facsimile signaling.

Preferably, the step (c) comprises using the processing unit for scanning the one of the one or more sheets.

More preferably, the method further comprises a step (d) of generating at least one coded image based on the scanning.

More preferably, the method further comprises a step (e) of recording the at least one coded image.

More preferably, the method further comprises a step (e) of transmitting the at least one coded image to a separate computing unit.

More preferably, the step (e) is done using a modem with facsimile signaling.

Preferably, the conveying is done in a helical manner.

Preferably, the non-linear path is annular.

Preferably, the conveying is done using one or more sheets conveyer.

According to another aspect of the present invention there is provided a cylindrical multifunction device for processing one or more sheets. The cylindrical multifunction device comprises an internal assembly having an external side, an external cylindrical housing having an internal side, the internal side of the external cylindrical housing is positioned relative to the external side of the internal assembly to form an annular feeding path therebetween, wherein the external cylindrical housing and the internal assembly are concentric. The cylindrical multifunction device further comprises a processing assembly coupled to the internal assembly, the processing assembly is positioned adjacent to the annular feeding path. The cylindrical multifunction device further comprises a feed assembly for feeding the one or more sheets through the annular feeding path and rotating the processing assembly along the sheet.

According to another aspect of the present invention there is provided a processing device for processing one or more passing sheets. The processing device comprises a processing assembly for applying processing to the at least one passing sheet, and a feed assembly for passing the at least one passing sheet by the processing assembly, wherein each one of the dimensions of the processing device is smaller than the width and length of the at least one passing sheet.

According to another aspect of the present invention there is provided a printer for printing on one or more sheets in a continuous manner. The printer comprises a processing assembly for applying processing to a printing area, the printing area having dimensions defined by length and width substantially smaller than the length and width dimensions of the one or more sheets for printing on the one or more sheets, and a feed assembly for positioning areas of the one or more sheets by the printing area in a continuous unidirectional motion.

According to another aspect of the present invention there is provided a printer for printing on a passing sheet. The printing device comprises an inkjet printing assembly for applying processing to a printing area, the printing area having dimensions defined by length and width substantially smaller than the length and width dimensions of the at least one passing sheet, and a feed assembly for passing the passing sheet about the printing area using a single motor.

Unless otherwise defined, all technical and scientific terms used herein have the same meaning as commonly understood by one of ordinary skill in the art to which this invention belongs. The materials, methods, and examples provided herein are illustrative only and are not intended to be limiting.

Implementation of the method and device of the present invention involves performing or completing certain selected tasks or steps manually, automatically, or a combination thereof. Moreover, according to actual instrumentation and equipment of embodiments of the method and device of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and device of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic representation of an exemplary cylindrical sheet processing device having an external cylindrical housing and an internal assembly, according to a preferred embodiment of the present invention;

FIG. 2 is a schematic sectional view of an exemplary cylindrical printer, according to a preferred embodiment of the present invention;

FIG. 3 is a block diagram that depicts the relationship among electronic components which are related to the scanning module, according to one embodiment of the present invention;

FIG. 4 is a schematic representation of an exemplary cylindrical printer having a compact feeding mechanism, according to a preferred embodiment of the present invention;

FIG. 5 is a schematic representation of an external cylindrical housing of an exemplary cylindrical printer having a compact feeding mechanism, according to a preferred embodiment of the present invention;

FIG. 6 is a schematic representation of an exemplary helical conveying mechanism, according to a preferred embodiment of the present invention;

FIG. 7 is a schematic representation of the direction of motion of sheets which are helically conveyed through an annular path, according to a preferred embodiment of the present invention;

FIG. 8A is a schematic representation of an annular feeder having an annular feeding path, according to an embodiment of the present invention;

FIG. 8B is a schematic representation of a cylindrical printer having an annular feeder, according to an embodiment of the present invention;

FIG. 9 is a schematic side view of a cylindrical printer having a protracted feeding mechanism, according to an embodiment of the present invention;

FIG. 10 is a schematic side view of a cylindrical printer having a tripod, according to an embodiment of the present invention;

FIG. 11A is a schematic view of an exemplary spinning arm and motor of a protracted feeding mechanism, according to an embodiment of the present invention;

FIG. 11B is a schematic top view of an exemplary conveyer of a protracted feeding mechanism, according to an embodiment of the present invention;

FIG. 11C is a schematic cross-section view of the exemplary conveyer of the protracted feeding mechanism, according to an embodiment of the present invention;

FIG. 12 is a schematic view of an exemplary curved batch of sheets which are conveyed through an annular path, according to an embodiment of the present invention;

FIG. 13 is a schematic sectional view of an exemplary cylindrical printer having a protracted feeding mechanism, according to an embodiment of the present invention;

FIG. 14 is a block diagram that depicts the relationship among electronic components associated with a man/machine interface unit, according to an embodiment of the present invention;

FIG. 15 is a simplified flowchart diagram of a method for processing an image using a cylindrical device having an annular feeding path and a processing unit, according to a preferred embodiment of the present invention;

FIG. 16 is a simplified flowchart diagram of a method for printing an image using a cylindrical device having an annular feeding path and a processing unit, according to an embodiment of the present invention; and

FIG. 17 is a simplified flowchart diagram of a method for scanning an image using a cylindrical device having an annular feeding path and a processing unit, according to an embodiment of the present invention.

### DETAILED DESCRIPTION OF THE EMBODIMENTS

The present embodiments comprise a printer or like sheet processing device, which is preferably substantially cylindrical, and a method for printing or otherwise processing sheets. The device may be used as a multifunctional device which is adapted to print on sheets, to scan sheets, and to receive and transmit coded images. Such a device may be used, inter alia, for receiving and transmitting facsimile transmissions of coded images using a modem with facsimile signaling.

The terms “substantially cylindrical” or “cylindrical” which are used in the present specification should be interpreted to include, for example, a cylindrical body or path having a spiral cross section, a coil-shaped cylindrical body or path, a conical-shaped body or path, an elliptic-shaped body or path, a body or path that approximates a cylindrical shape, and barrel-shaped body or path as well as the ordinary cylindrical body or path.

The device comprises two major parts, a processing assembly for applying processing, as described above to one or more passing sheets and a feed assembly for passing the sheets by the processing assembly via a non-linear path. This embodiment facilitates the creation of portable, easy to use, miniature personal sheet processing device, preferably configured for printing. The device may have a semi-circle, or a cylindrical shape that includes, preferably, a respective non-linear path. Since the path is non-linear, the width of the device is reduced below the length of the used printable media.

In one preferred embodiment the device is designed to have a cylindrical shape. The cylindrical design of the multifunction device facilitates the production of easy to carry and store devices. The device preferably comprises an internal assembly that comprises most of the hardware and an external cylindrical housing that defines the perimeter of the device. The external cylindrical housing is configured to encircle the internal assembly. The shape of the housing is adapted to the general shape of the device, the external cylindrical housing and the internal assembly are positioned so as to form an annular feeding path therebetween. Preferably, the external cylindrical housing and the internal assembly are concentric. A processing assembly which is preferably coupled to the internal assembly preferably comprises a scanning module and a printing module. The processing assembly is positioned adjacent to an annular feeding path, which allows the processing of sheets which are conveyed through the annular path. Preferably the sheets are conveyed in a helical manner so as to allow for positioning of each area of interest of the conveyed sheet in front of the processing assembly. Such a manner of conveyance further enables continuous processing of the document. All the areas of interest of the conveyed sheet are sequentially processed to generate a unified coded image of the sheet, or a printout that fully represents the coded image. In order to enable the helical conveyance of the sheet, the cylindrical multifunction device integrates a feed assembly.

Other embodiments of the present invention disclose a printing device for printing or otherwise processing passing sheets. The device comprises a stationary processing assembly for applying processing to a printing area. The printing area is defined by a length and a width which are each substantially smaller than the length and width dimensions of passing sheets. In order to promise the conveying of the sheet in a manner that allows the processing of approximately all the surface area of the sheet the device further comprises a feed assembly. The feed assembly is configured for feeding the sheets separately widthwise and lengthwise about the printing area.

Other embodiments of the present invention disclose a method for processing an image using a cylindrical device having an annular feeding path and a processing unit. The method includes the steps of curving one or more sheets, conveying the curved sheets through the annular feeding path, and using the processing unit for processing the sheets during the conveying. The ability to process curved sheets, preferably configured as a split tube, enables the cylindrical device according to the present invention to have a width which is substantially less than the width of the processed sheets, as described below.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

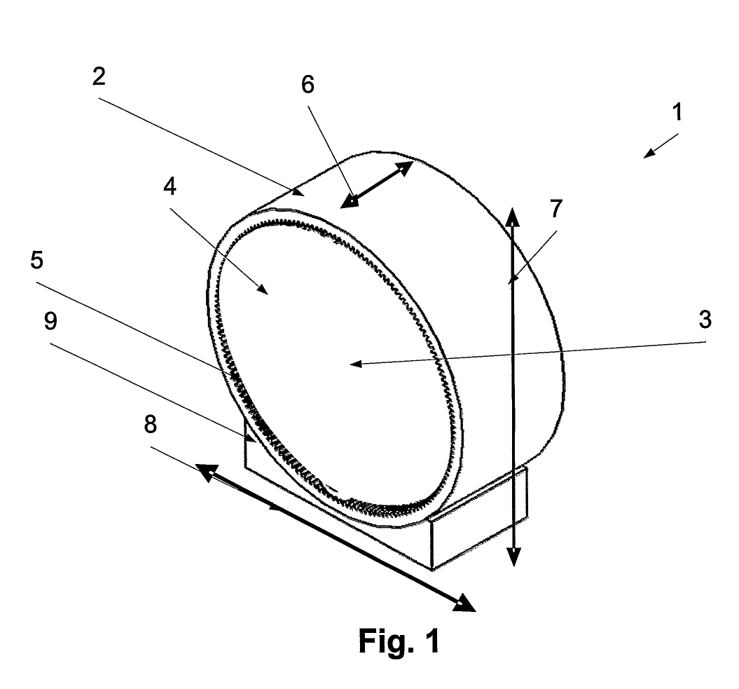

Reference is now made to FIG. 1 which depicts a preferred sheet processing device which is preferably configured as a printer 1 having an external housing 2 and an internal assembly 4. The external housing 2 is positioned to encircle the internal assembly 4.

As described above, since the sheets are designed to be conveyed via a non-linear path, preferably cylindrical, the sheet processing device has a relatively limited width. As depicted in FIG. 1, the printer 1 is designed as a narrow cylinder having a non-linear path 5 for a sheet. The non-linear path is preferably designed as an annular path. Since the annular path 5 is circular, the width of the cylindrical printer 1 is approximately a third of the width of a sheet. This relationship can be learned from the following set of equations:

PMW≅2·II·R

CW≅2·R

CW≅2·II·R/3≅PMW/3

Where PMW denotes the width of a sheet, CW denotes the width of the cylindrical printer 1, R denotes the radius of the annular path 5 of the cylindrical printer 1, and II is approximately 3.14. As shown by the last equation, the width of the cylindrical printer 1 is approximately equal to a third of the width of the sheet. For example, if the cylindrical printer 1 is designed to process commnonly used letter-sized paper sheets which are 216 millimeters wide (in the U.S.); the width of the cylindrical printer 1 may be slightly broader than 72 millimeters. The cylindrical printer 1 may be also designed for transparency sheets, photo paper sheets, paper sheets, cardboard sheets, letter-sized paper sheets, technical drawing sheets, poster sheets, flip chart sheets, large table sheets, note pad sheets, and standard visiting card paper sheets. The width of the cylindrical sheet processing device may be configured accordingly. Thus, it is clear that a cylindrical processing device which has been designed according to embodiments of the present invention will be substantially narrower than other devices which are designed to process the same-sized sheets in a flat configuration. The cylindrical printer 1 is not limited to handle sheets with certain dimensions. Therefore, it should be noted that sheet which have a width narrower than the length of the non-linear path, regardless to there length can be processed by the cylindrical printer 1.

It should be noted that in a preferred embodiment of the present invention the sheet processing device has a semi-circle shape or any other shape that allows the conveying of sheets via a non-linear path.

In a preferred embodiment of the present invention, the dimensions of the cylindrical printer are as follows: 25 millimeters deep, as shown at depth 6; 89 millimeters high, as shown at height 7; and 85 millimeters wide, as shown at width 8. These dimensions enable the conveying of commonly used letter-sized paper sheets through the annular path 5. It should be noted that all the dimensions of the cylindrical printer are substantially smaller than the dimensions of the processed sheet.

The cylindrical printer 1 comprises a feeding mechanism which is used to feed sheets, one at a time, through the annular path 5. Preferably, the cylindrical printer 1 comprises a direct feeding mechanism that comprises an elaborate configuration of gears and rotating components which are designed, inter alia, to feed the sheets through the annular path 5. Preferably, the direct feeding mechanism is used to helically feed each sheet through the annular path 5, as will be discussed below.

Preferably, a base 9 is coupled to the external side of the external cylindrical housing 2. The base is used to stabilize the cylindrical printer 1 on a flat surface.

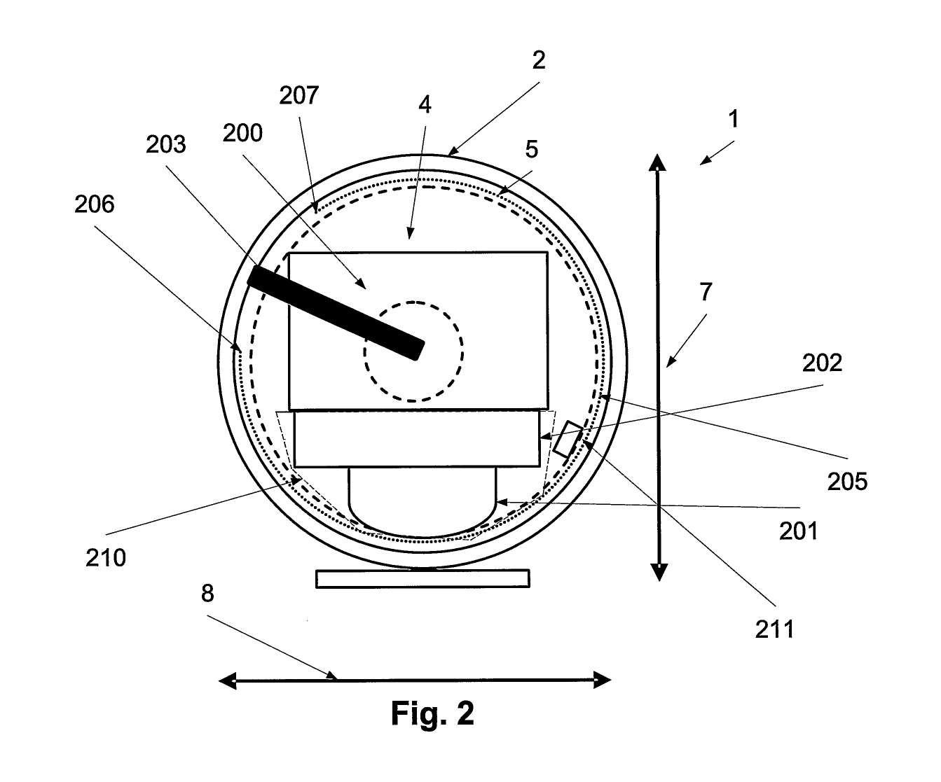

Reference is now made to FIG. 2, which shows a sectional view of a cylindrical printer 1 according to one embodiment of the present invention. The external cylindrical housing 2 and the internal assembly 4 are similar to those shown in FIG. 1 above. However, FIG. 2 further depicts internal components of the cylindrical printer 1.

One of the main advantages of the cylindrical printer 1 is its compactness. In order to maintain the size advantage, most of the components of the cylindrical printer 1 have to be positioned within the internal space of the external cylindrical housing 2.

A battery housing 200 for supplying power is positioned preferably above a processing assembly 210. Preferably, the cylindrical printer 1 further comprises an electric socket for supplying external power, positioned on the internal assembly 4. Preferably, the electric socket is used to charge batteries which are positioned in the battery housing 200.

The processing assembly 210 is positioned adjacent to the periphery of the internal assembly 4, directly in front of the annular path 5, such that the surface of each sheet which is conveyed through the annular path 5 will pass in front of the processing assembly 210.

Preferably the processing assembly 210 comprises a printing module 201. The printing module 201 is adapted to print on an area of a sheet which is positioned in front of it. Preferably, the printing module 201 comprises an inkjet printhead that contains a series of nozzles which are configured to spray drops of ink. The series of nozzles of the inkjet printhead are disposed relative to the annular path 5 such that the printing module 201 is configured to print on the sheet conveyed via the annular path 5.

Preferably, the printhead of the printing module is connected to an ink repository 202 which is used to store ink. Preferably, the ink repository 202 comprises a dispenser which is used to house and control one or more ink cartridges. The ink cartridges may come in various combinations, such as separate black and color cartridges, color and black in a single cartridge or a cartridge for each ink color. Preferably, the cartridges of the ink repository 202 and the printhead of the printing module are integrated into one or more replaceable unit. Preferably, a Cyan Magenta Yellow black (CMYK) printing module is used to allow the printer to output color prints.

Preferably, the printing module 201 comprises thermo-printing head with a heat-sensitive printing section including a thermal head. The thermal head realize stable printing on a printing heat-sensitive paper. The thermal head performs the printing using a variety of technologies which are generally well known in the art and are, therefore, not described here in greater detail.

The cylindrical printer 1 further comprises control circuitry and a communication interface. The processing assembly 210 communicates with the control circuitry, which is configured to control sheet processing. During the printing process, the control circuitry receives coded images from a computing unit through a communication interface, as described below. Preferably, the control circuitry stores a certain amount of received data in a designated buffer. Preferably, the designated buffer has approximately 32 MB of random access memory (RAM). The buffer allows the computing unit to complete the printing task, instead of having to wait for the actual coded image to be printed.

The received coded images are translated by the control circuitry to operational instructions which are transmitted to the printhead module and to the ink repository 202. The control circuitry synchronically transmits respective operational instructions to a propulsion mechanism that comprises one or more spinning motors which are used to convey sheets in front of processing assembly 210, as described below. Preferably, the control circuitry comprises drivers which are used to operate the printhead, the ink repository 202, and the propulsion mechanism.

As in many other printers, the cylindrical printer 1 comprises a communication interface that facilitates communication with computing units and the reception of printing instructions and coded images. The communication interface may also be used for transmitting operation instructions and updates. Preferably, the communication interface is a wireless communication interface. In one embodiment, the communication interface comprises a radio frequency (RF) transceiver that communicates with another RF transceiver which is connected to a computing unit. Bluetooth®, a standard for short-range digital transmission, can be used as a communication protocol for the RF communication between the computing unit and the cylindrical printer 1. Wireless LAN communication can also be established to communicate with an RF transceiver which is connected to a computing unit. Standards such as 802.11, 802.11a, 802.11b, and 802.11g may be used to establish such a wireless standards of communication. Preferably, the communication interface comprises an infrared (IR) transceiver which communicates with another IR transceiver which is connected to a computing unit. Preferably, the communication interface comprises a cellular transceiver which communicates with a cellular network. The cellular transceiver enables the cylindrical printer 1 to receive online transmissions directly from the cellular communication network. Accordingly, the cellular transceiver is configured to receive transmissions of encoded images in transmission formats such as a facsimile signaling format, a Short Message Service (SMS), or a Multimedia Messaging Service (MMS). The cylindrical printer 1 uses the printhead module 201 to print the received coded images. Preferably, in order to receive facsimile transmissions, the cylindrical printer 1 integrates a modem with facsimile signaling, as described below.

Preferably, the cylindrical printer 1 comprises a communication interface, which provides wired communication. The communication may include an RS-232 connection, a parallel port, a serial port, a small computer system interface (SCSI) port, an Ethernet connection, a universal serial bus (USB) connection, a USB2 connection.

Preferably, connections such as the USB connection may be used to supply electrical power to the cylindrical printer 1, it should be noted that the wired communication interfaces are usually used when the cylindrical printer 1 is in a standby mode. Since the communication interfaces are preferably coupled to the internal assembly 4, the movement of the fed sheets may be blocked by a cable which is connected to the wired communication interface. When the cylindrical printer 1 is active, the wired communication interfaces may be used only if the connecting device is relatively small and therefore does not interrupt the conveyance of the sheets. An example for such a connecting device is a disk-on-key device or a USB Bluetooth® adapter for wireless communication.

Preferably, a 30 centimeter lengthener is coupled to the communication interface to allow the connection of a wire to the communication interface from a remote location during the processing of the sheet.

Preferably, the communication interface is used, inter alia, for updating drivers and other software components which are stored in the control circuitry. Preferably, the communication interface is used, inter alia, for outputting indications about the cylindrical printer 1. Such outputs may comprise information about the printing or the scanning process, system malfunctions, ink levels, battery status, etc.

As depicted in FIG. 2, the printing module 201 is positioned adjacent to the periphery of the internal assembly 4. Preferably, the nozzles of the printing module 201 are directed toward the annular path 5 in order to enable the printing on a sheet 205 which has been fed into the device 1. As described below, the cylindrical printer 1 comprises a helical feeding mechanism which is used to feed sheets. The feeding mechanism conveys each sheet in a manner such that all the areas on the surface of the sheet are shifted, preferably sequentially, in front of the printing module 201.

As described above, the annular path 5 is positioned in between the external cylindrical housing 2 and the internal assembly 4 of the cylindrical printer 1. In order maintain the annular path 5, the position of the internal assembly 4 within the external cylindrical housing 2 needs to be fixed relative to the external cylindrical housing 2. The annular path 5 is designed to allow the conveyance of a sheet 205 therethrough. The sheet 205 is curved to fit along the annular path 5, whereby the left edge 206 and the right edge 207 of the sheet 205 are positioned in a manner such that a mechanical arm 203 is disposed in between them. The operation of the arm is explained below.

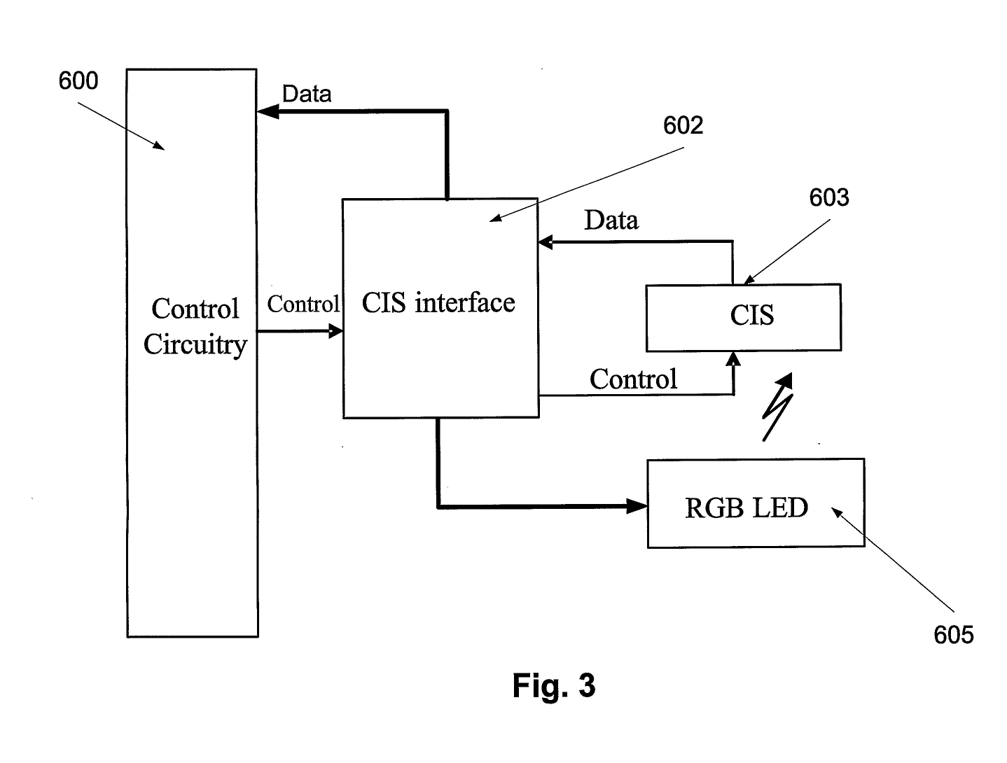

Reference is now made to FIG. 3 which is a block diagram that depicts the relationship among electronic components associated with an exemplary cylindrical sheet processing device such as a printer, according to an embodiment of the present invention. In this embodiment of the present invention the cylindrical printer is also lo used as a scanner.

In order to enable the optical scanning, the annular path is used to guide a document sheet which it is desired to be scanned. In such an embodiment the cylindrical printer 1 additionally comprises an optical scanning module. FIG. 3 depicts electronic components that comprise the optical scanning module. In order to adjust the control circuitry 600 for scanning, preferably a recordable memory, such as a flash memory or a random access memory (RAM) are added to the control circuitry 600. Preferably the optical scanning module comprises an optical scanner such as a contact image sensor (CIS) 603 having an image sensor array that preferably covers at least 8 mm scan width in 600 DPI resolution, and one or more red, green and blue (RGB) light emitting diodes (LEDs) 605. The LEDs are preferably configured for illuminating the sheet which is fed in front of the contact image sensor (CIS) 603. The illumination is preferably done in three consecutive cycles of green, red and blue. Preferably, each led requires approximately 20 mA for reliable operation. The CIS 603 and the LEDs 605 are located in the proximity of the annular path, as depicted in numeral 211 of FIG. 2.

In use, a document is helically fed through the annular path in the same manner as a sheet for printing is fed, as described above, with the portion of the document sheet that is to be scanned on the inner surface of the curved sheet. The CIS 603 is positioned adjacent to the periphery of the internal assembly 4. The image sensor array of the CIS and the LEDs are disposed toward the annular path 5. When a user initiates the optical scanning procedure, the control circuitry 600 transmits initiation instructions to a CIS interface 602 that operates the CIS and the RGB LEDs 605. The image sensor array of the CIS 603 gathers light originating from the RGB LEDs 605, and reflected from the document. Preferably, the light which is reflected from the document is gathered by a set of lenses and is directed at the image sensor array of the CIS 603. Accordingly, an image of the original document is captured by the CIS and is transformed, after synchronized A/D sampling, according to the intensity of light that is reflected to the image sensor array, into a digital representation in a predefined resolution, according to the used sensors and sampling rate. The digital representation is transmitted to the control circuitry 600 that records the images on the recordable memory, which is designed for storing the scanned images. The scanned images are preferably printed by the cylindrical printer, as described above, or transmitted via the communication device for the using of separate devices. Preferably, the scanned data is pre-processed in order to fix scanning errors, overlapping deviations, and other distortions of the scanned image.

Since the entire inner surface of the document sheet is conveyed in front of the image sensor array in helical manner, a continuous series of portions of the original document is stored on the recordable memory. Such a series may be used to generate a complete coded image of the original document. Preferably, the coded image is stored, or transmitted, using the interface communication in one of the following image formats: TIF, TIFF, PDF, JPG, GIF, PNG, BMP, WMF, EMF, PCX, and TGA. It should be understood that the CIS that performs the optical scanning may be replaced by a variety of technologies such as CCD, CMOS sensor etc, which are generally well known in the art and are, therefore, not described here in greater detail.

Preferably, the scanned image is transferred to a computing unit through the communication interface, as described above. Preferably, the cylindrical printer further comprises a memory card slot which is used to interface with a memory card. In such an embodiment, the recordable memory may be positioned on memory cards which can easily be replaced. The memory cards are preferably solid-state electronic flash memory data storage devices such as CompactFlash™ cards, SmartMedia™ cards, Memory Stick™ cards, Secure Digital™ cards, MiniSD™ cards, or MicroSD™ cards.

Reference is now made, once again, to FIG. 2. The combination of the printing module 201 and the optical scanning module enables the cylindrical sheet processing device which is configured as printer 1 to function as a facsimile, enabling the transmission of one or more images between remote locations. Preferably, the optical scanning module is used for scanning sheets and then transmitting one or more coded images over the cellular network and the public switch telephone network (PSTN) using the communication interface. In such an embodiment, the control circuitry 600 (FIG. 3) preferably further comprises a facsimile signaling module. When the cylindrical printer 1 is used to send a facsimile transmission, a cellular or line modem is used to generate an electronic representation of the original document text or graphics which have been scanned using the scanning module and then transmit it. In another embodiment, the electronic representation is transmitted, via the communication interface, to another device, such as a cellular phone or a personal computer that sends the fax through cellular network or via the switch telephone network (PSTN). When the cylindrical printer 1 is used to receive a facsimile transmission, the facsimile signaling module decrypts coded images which are received using the communication interface from another device. As described above, the facsimile transmission can be received either directly or via an external modem device. Accordingly, print instructions that represent the decrypted coded images are sent to the printing module, as described above.

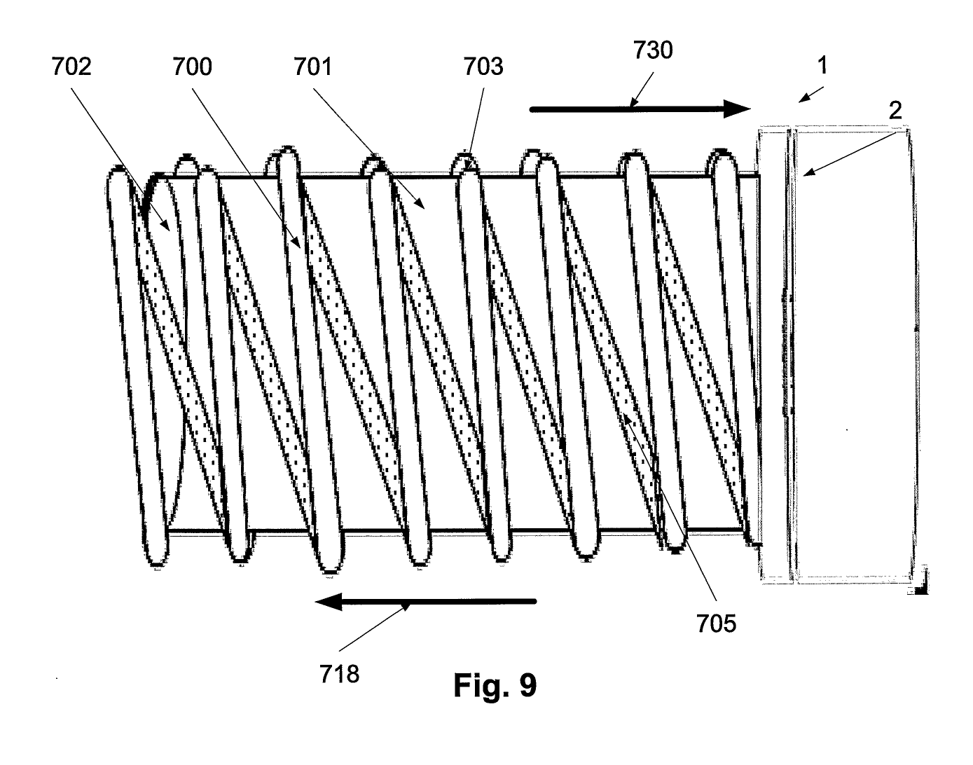

As described above, the processing assembly 210 and the optical scanning module 211 are positioned adjacent to the annular path, and are configured so as to be directed toward a sheet which is guided therethrough. In order to allow the printing module and optical scanning module to either scan the guided sheet or to print on the guided sheet, the entire inner surface area of the curved sheet has to be shifted in front of the processing assembly 210 and the optical scanning module 211. Preferably, the cylindrical printer 1 comprises a feeding mechanism that enables helical feeding of the sheet, which facilitates the shifting of any area of interest on the inner surface area of the curved sheet in front of processing assembly 210 and the optical scanning module 211. The helical feeding may be performed either by a direct feeding mechanism, as will be discussed below with reference to FIG. 4 or by a feeding mechanism that comprises a protracted conveyer, as preferably will be discussed below with reference to FIG. 9.

Reference is now made to FIG. 4, which shows a sectional view of one embodiment of the present invention. The external cylindrical housing 2 and the internal assembly 4 are similar to those shown in FIG. 2 above. However, this figure further depicts components of a compact helical feeding mechanism of the cylindrical printer 1, according to a preferred embodiment of the present invention, which is used to enable the helical feeding of the sheet through the annular path 5. FIG. 4 depicts a direct helical feeding mechanism which allows the helical feeding of sheet in an efficient manner. It should be noted that the direct helical feeding mechanism, which is depicted in FIG. 4, is only a preferred exemplary mechanism. The direct helical feeding mechanism may be any mechanic transmission which is configured for conveying a sheet through the annular path 5 in a manner that facilitates the shifting the entire inner surface area of the conveyed sheet in front of the processing assemblies, preferably in a continuous manner. Mechanic transmission may be understood as a gearbox, a set of gears and levers, cylinders and rollers of any shape, a set of bands and wheels, an hydraulic system, or any other system which is used for transmitting mechanical power from one or more prime movers, such as an engine or electric motor, to a mechanical powered output device.

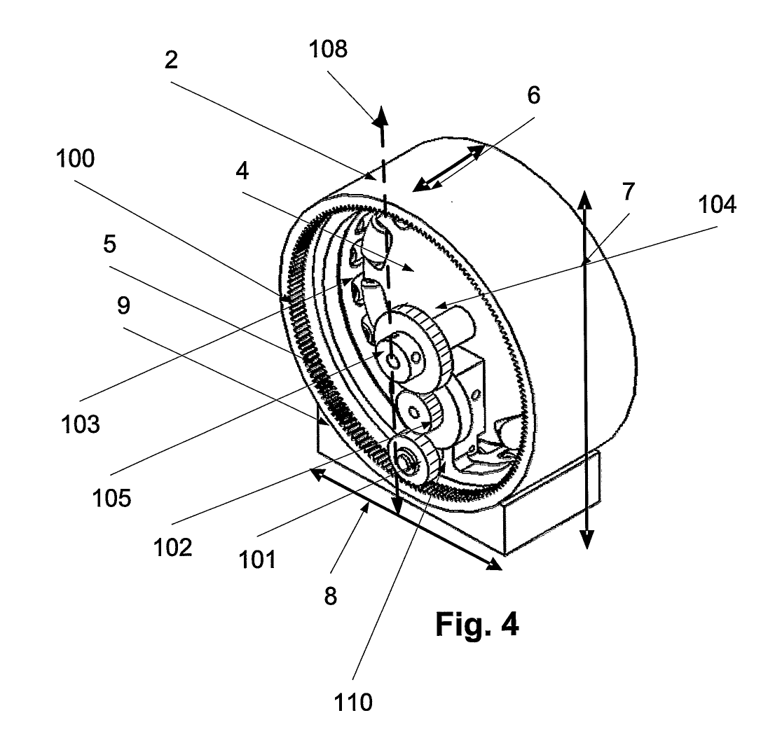

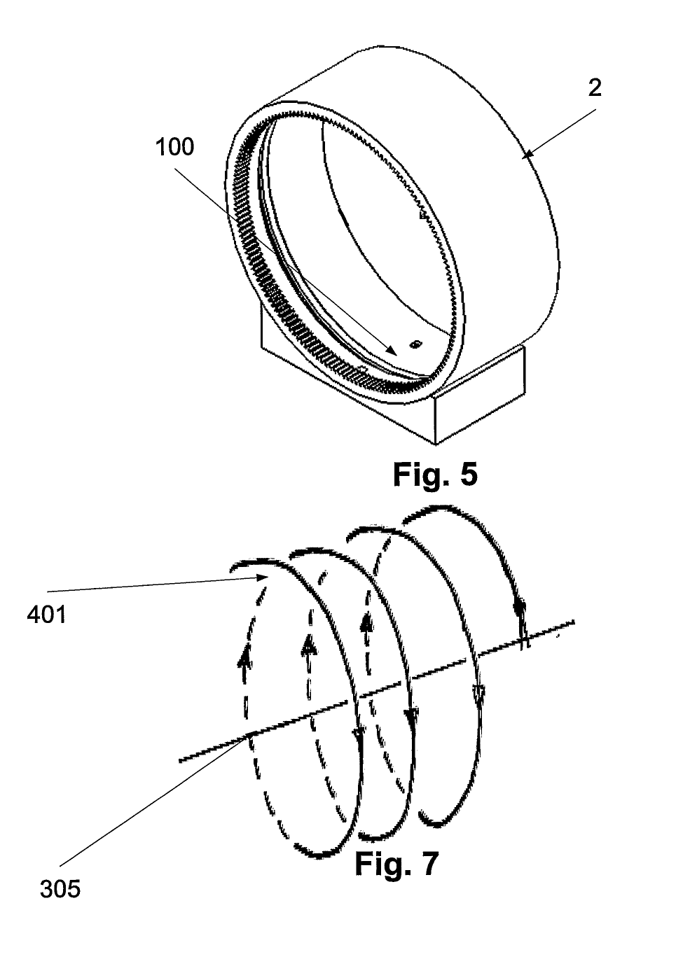

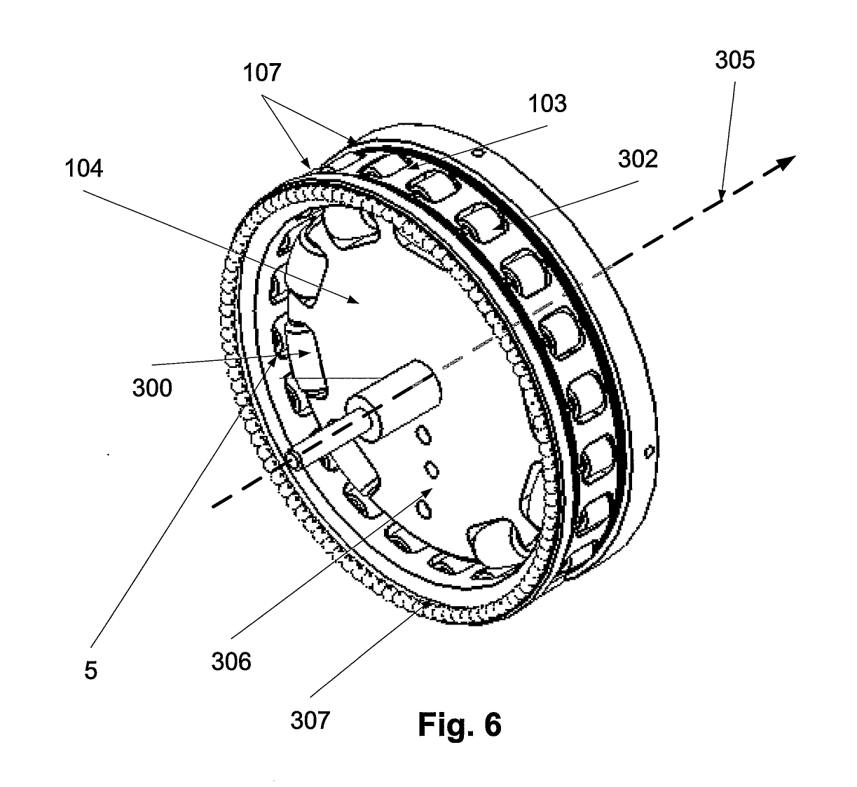

FIG. 4, as described above, described a cylindrical printer 1 with a preferred direct helical feeding mechanism. As shown, the edge of the internal side of the external cylindrical housing 2 is provided with a jagged band 100. Preferably, the jags of the jagged band 100 are provided around the internal side of the external cylindrical housing 2, as depicted more clearly in FIG. 5 which shows external view of an external cylindrical housing 2 having engraved jags 100. The jags are configured to allow an outer gear-wheel 101 to rotationally advance along the jagged band 100. The outer gear-wheel 101 is meshed with a middle gear-wheel 102 which is connected, as gear-wheel 101, to a supporting ring 110. The supporting ring 110 is coupled to the internal rounded base 104 and configured to rotate along the interior of the external cylindrical housing 2 of cylindrical printer 1. The middle gear-wheel 102 is further meshed with a central gear-wheel 105 which is connected to a main supporting element which is used to support the internal assembly 4 in position relative to the external cylindrical housing 2. In use, the rotational movement of the gear-wheels 101, 102, which are supported by internal rounded base 104 between jagged band 100 and gear-wheel 105, causes a sheet positioned in annular path 5 to be conveyed by the internal rounded base 104 rotation within the external cylindrical housing 2, as will be described more clearly with regard to FIG. 6. Such a configuration allows the positioning of the printing module and scanning module at a fixed point during the sheet processing. When a motor axle is connected to gear-wheel 102 or to internal rounded base 104 axle, as described below, the positioning of the printing module and scanning module is determined according to the directions and proportions of the gear-wheels motion. Preferably, as the outer gear-wheel 101 revolves along the jagged band 100, completing a full revolution, the middle gear-wheel 102 completes a full revolution along the jags of the central gear-wheel 105 while revolving in the opposite direction. As the middle gear-wheel 105 is coupled to internal assembly 4, the internal assembly 4 stays in a fixed position and does not rotate. The internal assembly 4 is preferably coupled to the electronic parts, the printing module, the cartridges, the scanning element, the batteries, and the one or more motors. Therefore, when the printing module and scanning module are coupled to the central gear-wheel 105, both stay on a fixed angle in relation to a corresponding angle of the external cylindrical housing 2. The configuration facilitates the placing of the printing module in a fixed perpendicular axis 108, in relation to the base of the cylindrical printer 9, during the printing process. The helical motion of the sheet in relation to the fixed position of the printhead ensures the shifting of all the areas of interest which are designated to be printed in front of the printhead. In other words, the feeding mechanism is designed to feed sheets through the annular path 5, in a continuous helical manner, in a certain direction while the printing module is preferably designed to stay on a fixed perpendicular axis 108, in relation to the base of the cylindrical printer 9, as the jagged band 100 is fixed to the external cylindrical housing 2.

As described below, a bearing placed in between the supporting ring 110 and external cylindrical housing 2 allows supporting ring 110 and the internal rounded base 104 which is attached to it, to rotate freely in relation to the positioning external cylindrical housing 2

In order to rotate the gear-wheels and actuate the helical feeding of the sheet, one or more of the gear-wheels are connected to an electric rotation motor. In one embodiment of the present invention, the motor is connected to gear-wheel 102. Preferably the electric rotation motor is a brushless DC (BLDC) motor.

The motor is connected to control circuitry which is used, inter alia, to control the operation of the motor rotation, as described above. The control circuitry receives one or more coded images from an external computing unit using the communication interface or from the scanning module. According to the received images the control circuitry instructs the electric motor and the processing assembly, as described above. The motor instructions are according to the requested motor speed, direction, and torque at any given moment during the printing process. Clearly, page size, the requested output resolution and other variable information are reflected in the instructions. Preferably, the control circuitry comprises a motor microcontroller and a metal oxide semiconductor field-effect transistor (MOSFET) driver which are used to enable the drive of the BLDC motor. Preferably, the BLDC motor comprises sensors. The sensors may be used for transmitting feedback signals to the motor microcontroller that comprise information about the revolutions per minute (RPM) of the motor, shaft position, rotation direction, and current position of the motor's axle. Other sensors may be used for recognizing the position of the processed sheet relative to the processing elements.

Reference is now made to FIG. 6, which shows the helical conveying mechanism, shown in FIG. 4, in more detail. Internal rounded base 104 has a set of barrel shaped wheels 300 and internal rotating annulus 103 has a set of cylindrical rollers 302. The internal rounded base 104 is concentrically positioned within the internal rotating annulus 103. Each of the barrel shaped wheels 300 is rotatable about a shaft which is positioned on the outer boundary of the internal rounded base 104. The wheels 300 are shaped as barrels for maintaining the annular structure of the annular path 5. The shafts are positioned along the plane of the internal rounded base 104, such that they approximate a circle along the periphery of the internal rounded base 104. A narrow space 306 for gear-wheels 101 and 102 is defined on the surface of the internal rounded base 104, within the circle defined by the barrel shaped wheels 300.

As described above, the internal rotating annulus 103 comprises a set of parallel cylindrical rollers 302. Each of the cylindrical rollers 302 encircles a shaft which is positioned on the internal rotating annulus 103. The shafts are parallel to each other, but are positioned at a slight angle of preferably 2.5 degrees relative to the axis of rotation 305 of the internal rotating annulus 103. The value angle is a derivative of printhead and scanning elements width and calculated in order to promise the conveying of the sheet in a manner that allows the processing of all the surface area of the sheet. Due to this orientation of the cylindrical rollers 302 in relation to the orientation of the barrel shaped wheels 300, the fed sheet is conveyed in a helical manner. The rotation of the barrel shaped wheels 300, with the rotation of the cylindrical rollers 302, directs the fed sheet in a diagonal movement vector relative to the axis of rotation 305. Axis 305 is also the axis of rotation defined by the helical feeding of a sheet through the annular path 5, which will be discussed below with reference to FIG. 7.

Preferably, in order to promise that the fed sheet stays in the helical feeding track which is depicted at FIG. 7, the shafts that hold the cylindrical rollers 302 are pushed by one or more elastic bands 107 toward the barrel shaped wheels 300. The elastic bands 107 are positioned between the external cylindrical housing 2 and the internal rotating annulus 103 main body, above the ends of the shafts that support the cylindrical rollers 302. The elasticity of the elastic bands 107 allows the loading of the fed sheet by allowing temporal broadening of annular path 5 according to fed sheet thickness. As the elastic bands 107 apply pressure on the shafts, a friction is maintained between the cylindrical rollers 302, the fed sheet and the barrel shaped wheels 300. Such friction allows the conveyance of the fed sheet in a helical motion.

Preferably, a bearing is positioned at one or more of the points of contact of the supporting ring 110 and the external cylindrical housing 2. Preferably, a ball bearing 307 which operates on the principle of rolling friction is used for antifriction. The friction is reduced by the rolling action of a set of hard steel balls. The movement track of the set of hard steel balls is determined by a groove which is formed along the annular contact area of the external cylindrical housing 2 and supporting ring 110 that coupled to internal rounded base 104. The bearing is used to reduce the friction between the supporting ring 110 and the external cylindrical housing 2, so that the supporting ring 110 and the internal rounded base 104 that couple to it may move freely in relative to the external cylindrical housing 2. There are numerous bearing mechanisms which are capable of reducing friction, which are well known in the art and, hence, will not be described here in detail.

As depicted in FIG. 6, the cylindrical rollers 302 are positioned adjacent to the barrel shaped wheels 300. The annular path 5 is located in between the cylindrical rollers 302 and the barrel shaped wheels 300. The rotation of the internal rounded base 104 and the barrel shaped wheels 300 in relation to the cylindrical rollers 302, results in a sheet disposed in annular path 5 to be guided therethrough. The rotation conveys the sheet through the annular path 5 in a helical manner, as shown at 401 in FIG. 7, wherein the axis of helical movement 305 is also shown. The helical movement is an outcome of the slight angle of the shafts of the cylindrical rollers 302. In another embodiment of the present invention the barrel shaped wheels 300 and the cylindrical rollers 302 are switched, such that the barrel shaped wheels are positioned on the cylindrical annulus 103 and the cylindrical rollers are positioned on the internal rounded base 104.

In another embodiment of the present invention, a magnet based mechanism is used to control the positioning of the internal assembly 4. In order to sequentially shift the areas of interest of the conveyed sheet in front of the processing assembly, the rotational positioning of the processing assembly and the sheet has to be synchronized. The magnet based mechanism generates a magnet force which is used to control the positioning of the internal assembly 4. Preferably, the magnetic force is used to fix the positioning of the internal assembly 4 in relation to the helical movement of the sheet and to fixate the rotational angle of internal assembly 4 when the motor rotates the internal assembly 4.

Preferably, a set of magnetized components is coupled to internal assembly 4. The set of magnetized components is disposed in manner such that, for each component, a certain magnetic pole is directed toward the annular path 5. An additional set of magnetized components is coupled to the external cylindrical housing 2. The additional set of magnetized components is disposed in a manner that, for each component, an opposite magnetic poles are directed towards the annular path. Since the poles of the sets of magnetized components which are coupled to the internal assembly 4 and to the external cylindrical housing 2 are inverted, a magnetic field is generated. Preferably, the magnetic field fixes the position of the internal assembly 4 relative to the helical movement of the sheet and to assure that the internal assembly 4 will not rotate. Preferably, the one or more magnetic elements of each set are electro-magnets which electrically controlled in order to stabilize the internal assembly 4 position by controlling the magnetic force between them.

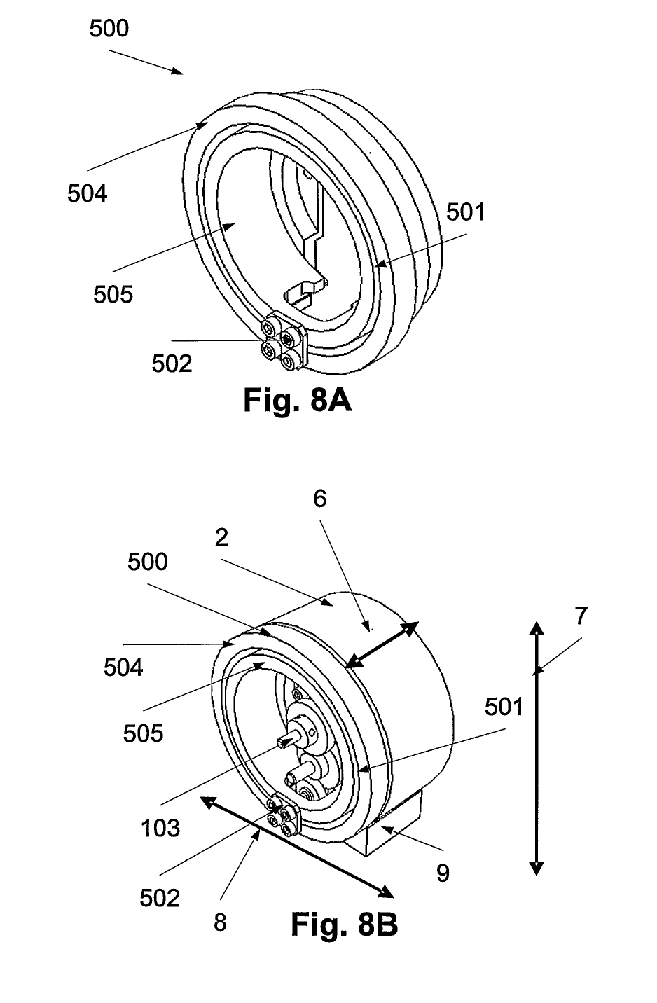

Reference is now made to FIGS. 8A and 8B, which show an annular feeder 500 which may be used in accordance with the cylindrical printer 1 according to the present invention. FIG. 8A depicts an annular feeder 500 having an annular feeding path 501, according to an embodiment of the present invention. In FIG. 8B the annular feeder 500 is shown in position on a cylindrical printer 1, described above with regard to FIGS. 1, 2, and 4.

The annular feeder 500 comprises an external cylinder 504 and an internal cylinder 505. The internal cylinder 505 in positioned within the external cylinder 504 in a manner such that an annular feeding path 501 is formed therebetween. Preferably, the position of the internal cylinder 505 relative to the external cylinder 504 is fixed using a narrow bridge 502. Preferably, the width of the narrow bridge 502 is similar to that of the narrow space 306 for gear-wheels which is defined on the surface of the internal rounded base 104 shown in FIG. 6.

The annular feeder 500 is used to guide sheets, one at a time, through the annular feeding path 501. The outer surface of the internal cylinder 505 is tapered toward the inner surface of the external cylinder 504, so as to provide the internal cylinder with an angular structure. This structure allows one or more sheets to be inserted into the annular feeder 500 to be directed toward the annular path 501, while only one sheet at a time is allowed to actually enter into the annular feeding path 501. In use, one or more sheets are curved to fit the annular feeding path 501. The left and right boundaries of each sheet are positioned in a manner such that the narrow bridge 502 is positioned between them. The sheets are helically conveyed, one by one, along the feeding path 501.

Reference is now made to FIG. 9, which shows a side view of an embodiment of the present invention. The external cylindrical housing 2 and some of the internal components of the cylindrical printer 1 are similar to those shown in FIG. 1 above. However, this figure further depicts a spring-shaped conveyer 700, within which there is disposed at least one sheet in a pre-printing position. The spring-shaped conveyer 700 is coupled to a cylindrical printer (not shown) that integrates a protracted feeding mechanism.

As described above, sheets may be directly conveyed, one by one, through the annular path without any supporting device. However, as was mentioned above, a plurality of sheets may also be helically conveyed, using a sheet conveyer. Preferably, a spring-shaped conveyer 700 is provided to convey sheets 701 through the annular path 5.

Helical grooves are disposed on the internal side of the external cylindrical housing 2 in order to allow the spring-shaped conveyer 700 to helically feed one or more sheets 701 through the annular path 5. The helical grooves are configured to direct the motion of the sheets along a predefined helical track. Preferably, the helical grooves are oriented at a two and half degrees deviation in relation to the planner which is vertical to the axis 305 (FIG. 7) of the cylindrical sheet processing device which is preferably used for printing. The predefined helical track resembles the helical manner of conveying a sheet which is depicted at numeral 401 of FIG. 7. In use, the spring-shaped conveyer 700 holds a curved batch of sheets 701 within its bands. Preferably, the spring-shaped conveyer 700 is designed to convey a batch of approximately eight A4 sheets, through the annular path 5 during the printing or the scanning process of the cylindrical device. When the cylindrical device is in inactive mode, the spring-shaped conveyer 700 is configured to be compressed in a manner that will be described below in detail.

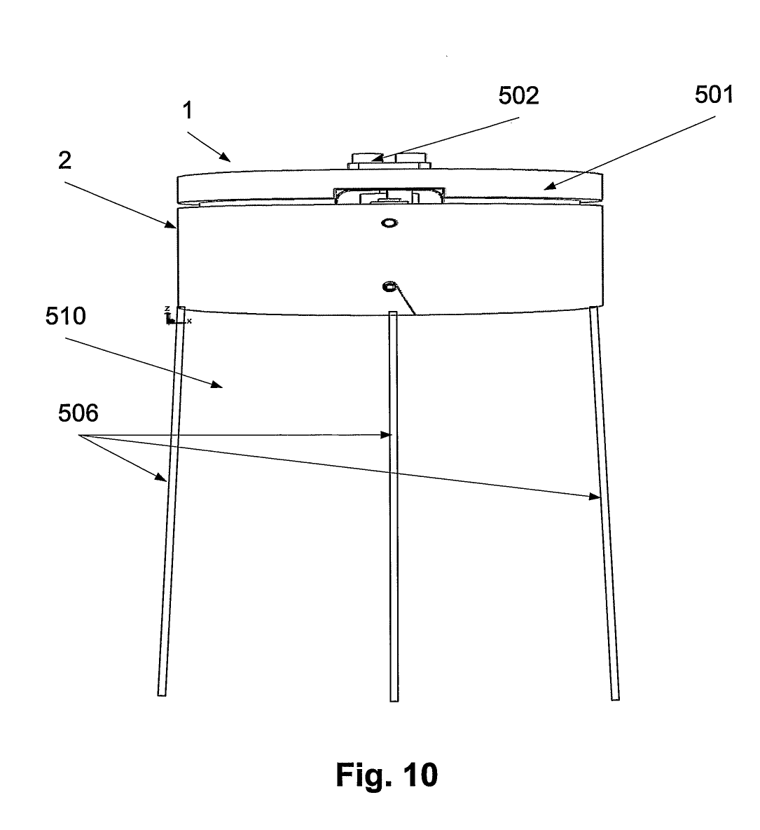

Reference is now made to FIG. 10, which shows a side view of one embodiment of the present invention having a removable tripod. The external cylindrical housing 2 and the annular feeder 500 are similar to those shown in FIG. 8B above. However, this figure further depicts a removable tripod 510 for vertically positioning the cylindrical printer 1 relative to a flat surface. Preferably, the tripod comprises three telescopic legs 506 having, preferably, a maximum length of 320 millimeters and a minimum length of 60 millimeters. In order to maintain the miniature size of the printer, each one of the three telescopic legs 506 is connected to the cylindrical printer via a designated connection. The connection allows folding the leg tangent to the cylindrical printer body. Since the preferred width of the cylindrical printer is 85 millimeters and the length of the telescopic leg 506 is preferably 60 millimeters in a close state, the folded legs do not substantially affect the cylindrical printer 1 dimensions.

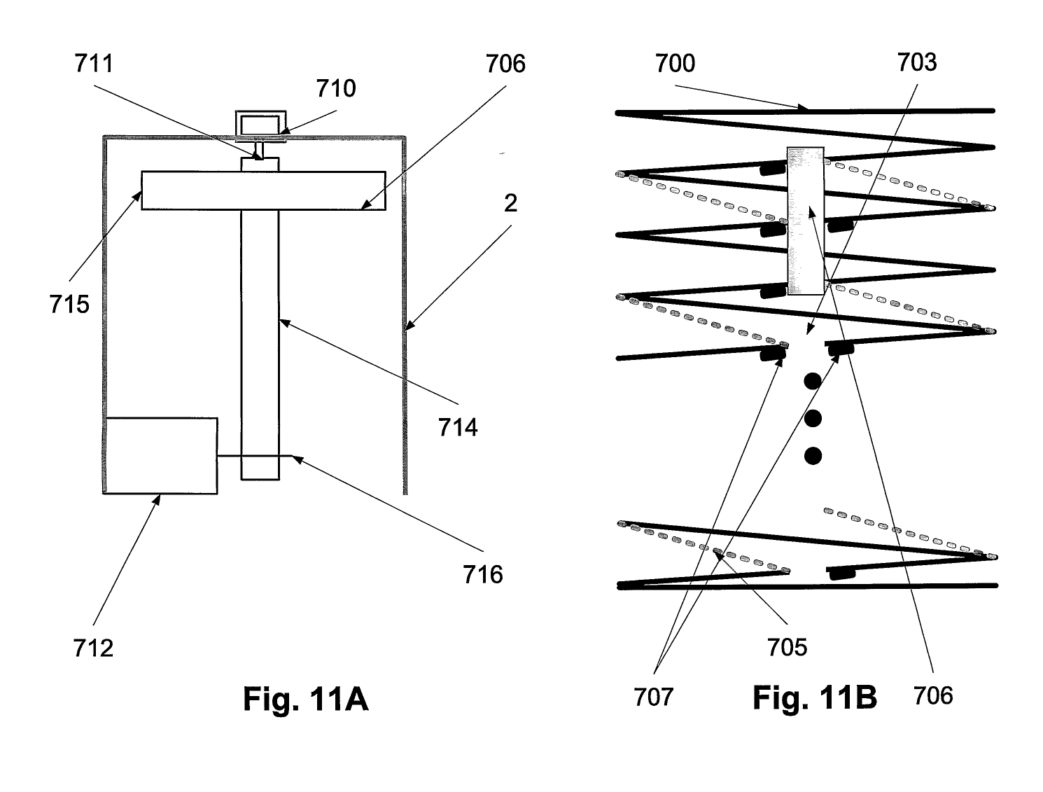

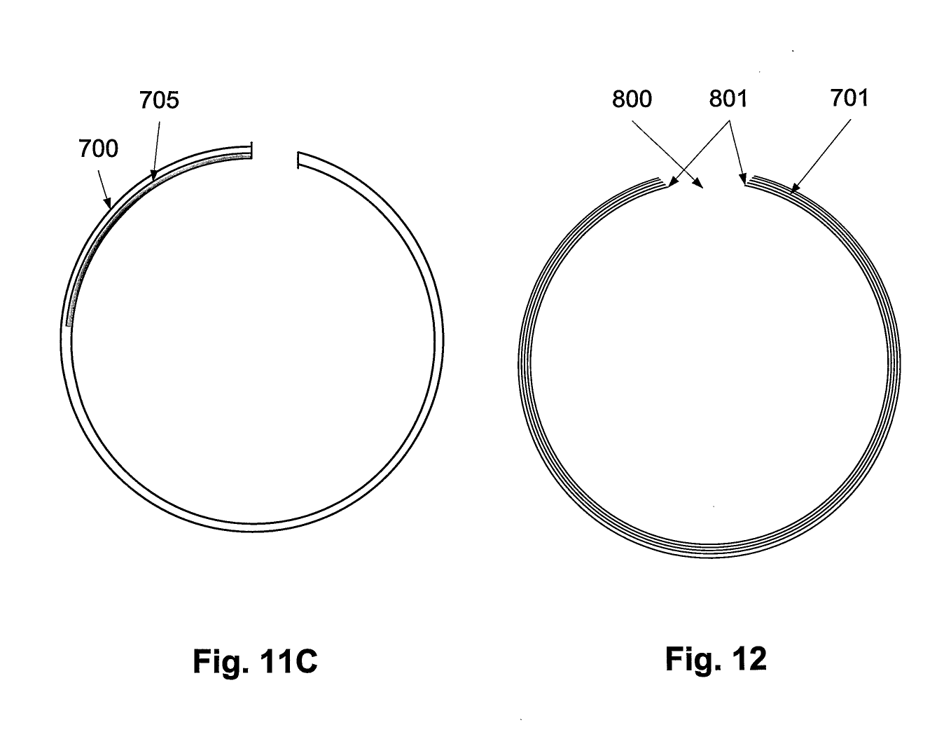

Reference is now made to FIGS. 11A, 11B and 11C, which show different components of the protracted feeding mechanism. FIG. 11A shows an exemplary, illustrative spinning arm 706 and a motor 712 according to one embodiment of the present invention. FIG. 11B shows an exemplary top view of the spring-shaped conveyer 700 and the spinning arm 706. FIG. 11C shows an exemplary cross-section view of the spring-shaped conveyer 700.

As described above, the spring-shaped conveyer 700 is designed to helically convey a curved batch of sheets via the annular path. In order to set in motion the sheets disposed within the spring-shaped conveyer 700, the protracted feeding mechanism comprises a propulsion mechanism. Preferably, the propulsion mechanism includes a motor 712 positioned concentrically relative to the external cylindrical housing 2. The motor 712 is used to rotate the spinning arm 706 which is used to rotary push and pull the spring-shaped conveyer 700. The spinning arm 706 comprises a lever 714 which is connected to the axle 716 of the motor 712 on one side, and on the other side, to a lengthened portion 715 which is adapted to fit in a slit 703 that extends along the spring shaped conveyer 700.

Preferably, the spring shaped conveyer 700 comprises a plurality of bands which are widened at the ends thereof. Each pair of opposite edges 707 of the bands preferably comprises a push-pull mechanism. The push-pull mechanism is complex of fasteners which are configured to allow the pulling of one end while applying rotational pushing force on the other end.

Preferably, each pair of opposite edges 707 of the bands comprises a sheet holder mechanism. The sheet holder mechanism is used for holding the inner most sheets during the sheet processing process.

More preferably, the lengthened portion 715 is designed in a manner such that each side contacts at least two bands 707 pairs of the spring-shaped conveyer 700.

Preferably, each side contacts at push-pull mechanisms which are respectively connected to two adjacent pair of opposite edges 707 of different bands.

Preferably the lengthened portion 715 is approximately 20 millimeters long.

As depicted in FIGS. 9, 11B and 11C, connection strips 705 are positioned to connect the bands of the spring shaped conveyer 700. The connection strips 705 are used to join the bands of the spring-shaped conveyer. The connection strips 705 are positioned in a manner that allows the compression of the spring-shaped conveyer 700, as described below.

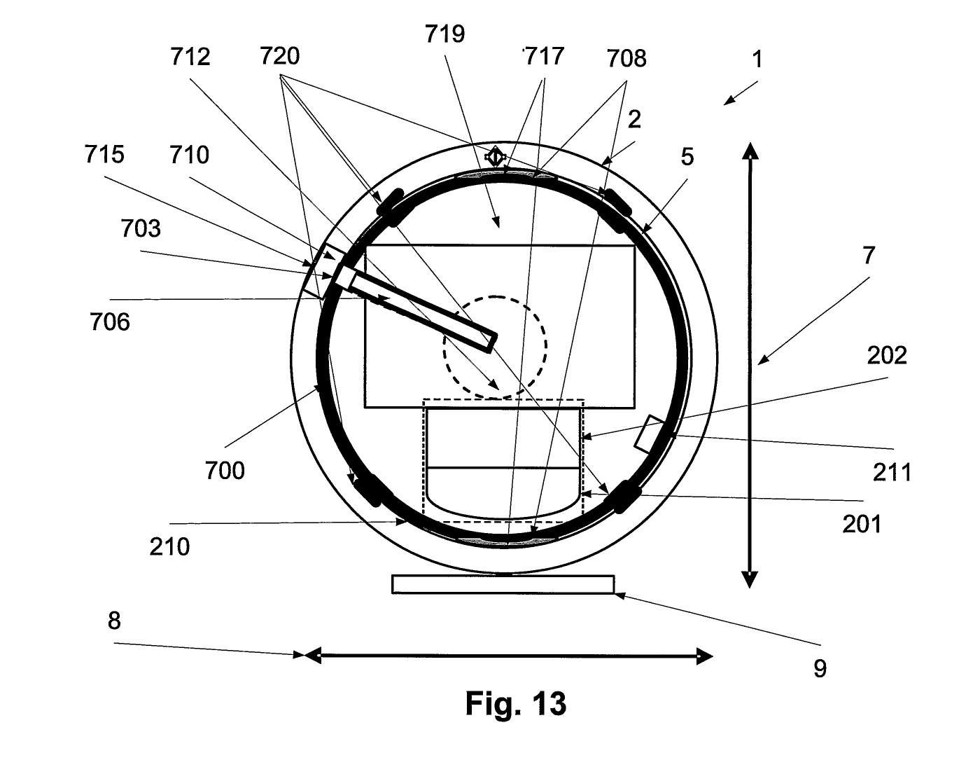

As was described above, the lengthened portion 715 and the slit 703 are adapted to allow the positioning of a curved batch of sheets along the spring-shaped conveyer 700 in a manner such that the lengthened portion 715 is positioned in between the left edge and the right edge of the curved batch of sheets. In use the spinning motor 712 rotates the lever and the lengthened portion 715. The motion of the lengthened portion 715 rotary pushes and pulls the spring shaped conveyer 700, causing it to helically move within the helical grooves, as shown at numeral 708 of FIG. 13, which are disposed on the internal side of the external cylindrical housing. The helical movement of the spring shaped conveyer 700 helically conveys the batch of curved sheets via the annular path.

In one embodiment of the present invention the spinning arm 706 comprises a projection 710 which is used to fixate the spinning arm 706 within the external cylindrical housing in both radial and axial direction. The spinning arm 706 preferably fixates, by the projection 710 and the narrowed portion 711, the position of the internal assembly 719 within the external cylindrical housing in relation to the radial direction and to the axial direction of the external cylindrical housing. Preferably, the projection 710 is designed to pass through a slit which is disposed on the internal side of the external cylindrical housing 2. The slit is adjusted to enable the rotational motion of the spinning arm 706 with no axial motion. Preferably, the projection 710 comprises a narrowed portion 711 in order to hold the spinning arm 706 and the internal assembly 719, which hold the spinning arm 706 through the motor axis 716—in the radial direction.

Reference is now made, once again, to FIG. 9. In use, after the spring shaped conveyer 700 has finished conveying the curved batch of sheets 701 through the annular path in the direction of arrow 730, as described above, the printing of the innermost sheet has been completed. The same push and pull mechanism of spinning arm 706 that is used to forwardly convey 718 the spring shaped conveyer 700 and the curved batch of sheet 701 is used to backwardly convey 730 the spring shaped conveyer 700 and the curved batch of sheets 701 after the printing of the internal sheet has been completed. Preferably, the spinning motor is configured to rotate in both directions. Such a spinning motor is used to rotary push and pull the spring shaped conveyer 700 in the backward direction 718, returning the spring shaped conveyer 700 to the pre-printing position. Preferably, during the movement of the spring shaped conveyer 700 in backward direction 718 the innermost sheet is being processed.

As depicted above, a curved batch of sheets 701 may be conveyed through the annular path. However, after the curved batch of sheets 701 have been conveyed through the annular path, the printing on the internal side of the internal sheet has been completed. In order to expose the following sheet to the processing assembly, the printed sheet has to be released from the batch.

Reference is now made to FIG. 12, which depicts the curved batch of sheets 701. As depicted, the pages that comprise the curved batch of sheets 701 are placed one on top of the other. Each sheet is curved to form a split-tube structure having a gap 800. Since the sheets are placed one on top of the other, each sheet forms a split-tube structure with a different radius. Thus, since presumably all the sheets have the same width, the longer the radius, the wider the gap of the split-tube structure. Accordingly, the innermost sheet forms a split-tube structure having the narrowest gap. This characteristic allows the latching of the innermost sheet using designated fasteners 707 for releasing the innermost sheet after it has been printed. Preferably, the sheet holder mechanism is used to release the innermost sheet by releasing it's holding on the innermost sheet and fastening the consecutive sheet. In use, the exposed edges 801 of the upper side of the innermost sheet are gripped when the rest of the sheets are conveyed backward using the spring-shaped conveyer. The gripping of the edges facilitates the release of innermost sheet, exposing the inner surface of the following sheet. After the spring-shaped conveyer has been fully conveyed backwards, the innermost sheet drops asides from the cylindrical printer.

Reference is now made, once again, to FIG. 9. As described above, the spring-shaped conveyer 700 is positioned in front of the annular path. The spring-shaped conveyer 700 substantially increases the depth dimension of the cylindrical printer 1.

In order to maintain the compact size of the cylindrical printer 1, the spring-shaped conveyer 700 may be compressed when the cylindrical printer 1 is not in use. Preferably, a pair of clips (not shown) is coupled to the outer side of the internal assembly 719. The pair of clips is used to maintain the spring-shaped conveyer 700 in a compressed state. This allows the user to minimize the size of the cylindrical printer 1 when not in use. In one embodiment of the present invention, the device may be compressed during the backward movement of the spring-shaped conveyer 700. Preferably, clips are used to bias the spring by holding the spring-shaped conveyer 700 during its backward movement after the printing process on the last sheet has been completed. The control circuitry controls the pair of clips state during the sheet processing.

In one embodiment of the present invention, the compressed spring-shaped conveyer may be extended to its pre-printing configuration in a number of intermediary steps. In this manner, the user can easily position sheets on the spring-shaped conveyer 700. In one embodiment of the present invention, the cylindrical printer facilitates the loading of the sheets by allowing the user to perform several steps. Initially a batch of sheets is curved by the device user to form a split tube shape. The radius of the split tube shape, which is formed by the curved sheets 701, is preferably smaller than the radius of the spring-shaped conveyer 700. The curved sheets 701 are then conveyed manually by the user across the compressed spring-shaped conveyer 700 until it is obstructed by the aforementioned pair of clips or the internal assembly. In the following step the user releases his holding in order to allow the positioning of the top end of the curved sheets 701 within the compressed spring-shaped conveyer 700. After the sheets are set in place, the user preferably initiates the decompression of the spring-shaped conveyer 700 by shifting the clips pair in a way that allows the spring shaped conveyer 700 to pass through the printer body.

Additional reference is now made to FIG. 13, which shows a sectional view of an embodiment of the present invention. As described above, motor 712 is coupled to the internal assembly 719. In order to allow the motor 712 to rotary push-pull the spring-shaped conveyer, the spinning arm 706 driven by the motor has to rotate in relation to the exterior cylindrical housing 2. In order to allow the rotation of the spinning 706 in relation to the exterior cylindrical housing 2, the internal assembly 719 has to be fixed firmly.

In one embodiment of the present invention, a magnetic mechanism is used to firmly fix the internal assembly 719 in relation to the rotational direction of the external cylindrical housing. Preferably, the magnetic mechanism comprises a pair of magnetic components. Each magnetic component has an attraction site at its top end. One component is coupled to the internal assembly 719, and the second component is coupled to the external cylindrical housing 2. The top end of each magnetic component is positioned in a manner such that it tends toward the annular path 5. Preferably four pairs of magnetic components 720 are positioned along the annular path 5.

As described above, a slit 703 extends along the spring-shaped conveyer 700 in order to allow the lengthened portion 715 of the spinning arm 706 to rotate the spring-shaped conveyer 700. In order to effect the helical movement of the spring-shaped conveyer 700, as described above, helical grooves 708, comprising at least two bands 717 each, are coupled to the internal side of the external cylindrical housing 2. Preferably, the helical grooves 708 are positioned in a deviation of two and half degrees to the vertical axis of the cylindrical printer 1, as discussed above.

Preferably, the electric circuitry of the cylindrical printer 1 comprises a band distance estimator. The band distance estimator is configured to receive images of the spring-shaped conveyer 700 during its conveyance across the non-linear path. The band distance estimator analyzes the received images to estimate the distance between each pair of bands. The estimation is translated to instructions, which are used for determining sheet processing parameters during the sheet processing process.

It should be understood that the cylindrical printer 1 may comprise other feeding mechanisms. Sheets may be conveyed toward the processing assembly along any of a number of different paths. For example, the processing may be performed row by row or column by column. Alternatively, the processing assembly may be conveyed over the surface area of the sheet along any of a number of different paths.

As described above, the printing module 201 is adapted to print on an area of a sheet, which is positioned in front of it. In order to allow an accurate processing of the fed sheets, the printing module 201 has to be instructed with the exact movement of the sheet. Since the sheets are preferably fed in a helical manner, the sheet is not conveyed a line by line in front of the printing module, as in a regular Inkjet printer, but a diagonal by a diagonal. Preferably, the control circuitry is configured to instruct the printing module in respect of the diagonals. The control circuitry instructions compensate for the printing pattern deviation.

However, it should be noted that since the aforementioned protracted and compact feeding mechanisms are used to convey sheets in front of the processing assembly, they have low power consumption. As commonly known, the weight of each sheet is usually substantially lower than the weight of the processing assembly. Hence, it is clear that conveying sheets in front of the processing assembly will result in substantially lower electricity consumption than would be necessary for conveying the processing assembly over the surface area of the sheets. It should be noted that the low power consumption is an outcome of using a single motor in continues motion with no sudden accelerations and decelerations like conventional printers.

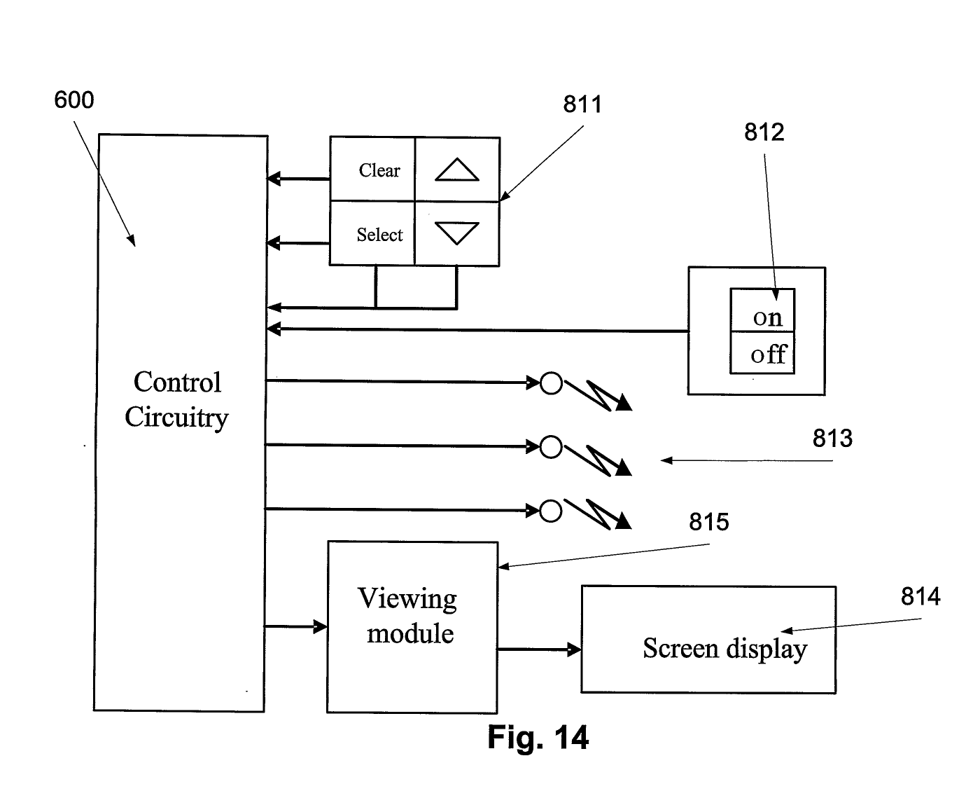

Reference is now made to FIG. 14, which is a block diagram that depicts the relationship among electronic components associated with a man machine interface (MMI) unit, according to one embodiment of the present invention. In order to allow users to operate the cylindrical printer, an MMI unit is coupled to the internal assembly 4. The components of the MMI unit communicate with the control circuitry 600 and allow the user to receive feedback regarding his instructions. Preferably, the MMI unit comprises a keypad 811 which is used to enter operational instructions. Preferably, a separate operation switch 812 is used to activate and deactivate the cylindrical printer.

Preferably, the MMI unit further comprises a set of three LEDs 813, where each LED is directly connected to and operated by the control circuitry 600. The set of three LEDs may be used to indicate errors and the current status of components of the cylindrical printer.

Preferably, the MMI unit further comprises a screen display 814 and a viewing module 815, which is used to convert information from the control circuitry 600 into viewing signals that are transmitted to screen display 814. Preferably, the screen display is a liquid crystal display (LCD) screen or an organic light emitting display (OLED) screen. Preferably, the viewing module 815 is used to stabilize reference voltage and control signals of the screen display 814. The MMI unit may be used to actuate the printing or the scanning process, to reset the printing or the scanning process, to define the size of the paper, to control and adjust the different modules of the cylindrical printer, to operate the different functions of the device, etc. In one embodiment of the present invention, the screen display 814 is used to display received coded images or scanned documents.

In one embodiment of the present invention, the cylindrical printer is configured to be operated from a remotely located computing unit, such as a cellular phone or a portable computer. Such a remote control is done using the aforementioned communication module.

In one embodiment of the present invention, the control circuitry 600 is connected to an audio module (not shown) having a playing means. The audio module may be used to convert information from the control circuitry 600 to audio signals for the playing means. Playing means may be understood as one or more speakers or a conventional earphone component. In an embodiment, the audio module and the screen display 814 may be used to play media files. As described above, the control circuitry 600 is connected to data memory storage. The data memory storage may be used, inter alia, to store media files. The media files may be stored in various file formats such as MP3, WMA, WAV, M4A and OGG for music files and AVI, WMV, MPEG, MOV, RAM and SWF for video files.

In another preferred embodiment of the present invention, the cylindrical printer is combined with a cell phone. The cell phone may be any mobile and/or portable device capable of conducting wireless communications, such as a personal digital assistant (PDA). The cell phone and the cylindrical printer are combined into a single mobile device capable of conducting wireless communication and processing sheets.

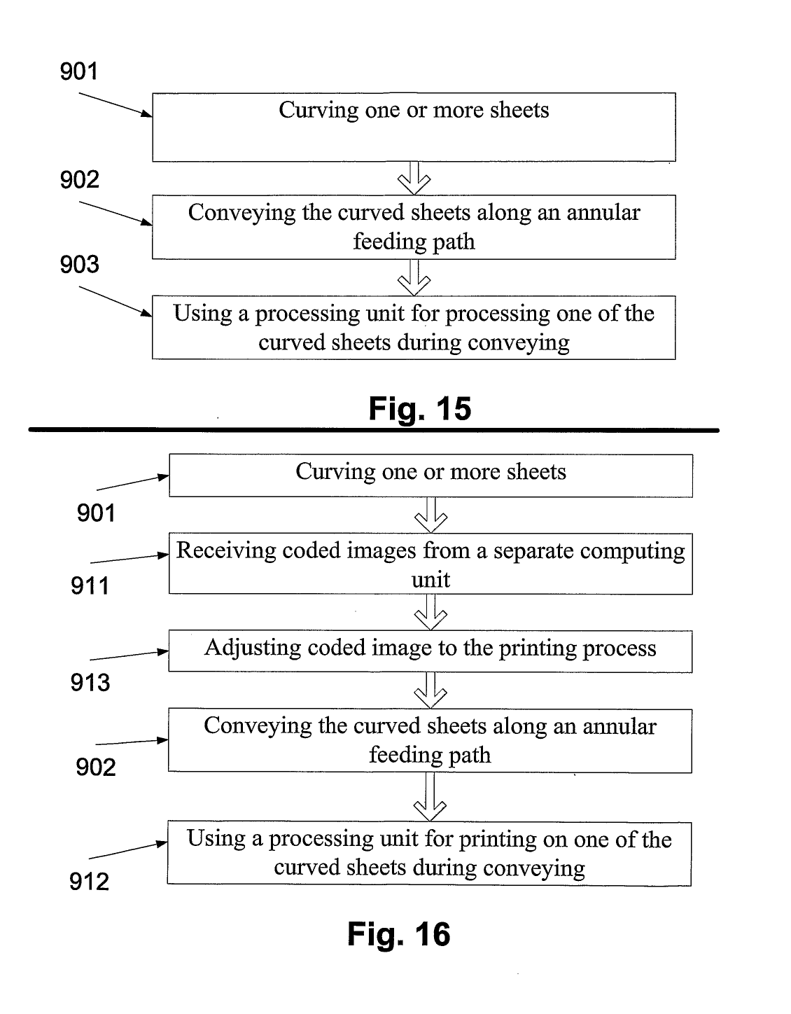

Reference is now made to FIG. 15, which is a flowchart of an exemplary method for processing an image using a device having a non-linear feeding path and a processing unit, according to a preferred embodiment of the present invention. Preferably, a cylindrical device having an annular path is used.

During the first step, as shown at 901, one or more sheets are curved to form a split-tube structure. The split-tube structure facilitates the conveying of the sheets through the annular feeding path of the cylindrical device. During the subsequent step, as shown at 902, the curved sheets are conveyed along the non-linear, preferably annular feeding path. Preferably, the curved sheets are helically conveyed along the feeding path. As shown at 903, during the conveyance of the curved sheets, a processing unit is used for processing one of the curved sheets. Processing may be understood as printing, scanning or any other form of subjecting the conveyed sheet to a series of automated procedures.

Reference is now made to FIG. 16, which is a flowchart of an exemplary method for printing using a cylindrical device according to an embodiment of the present invention. Steps 901-902 are as in FIG. 15 above. However, in FIG. 16, steps 911 and 913 are added. Subsequent to step 901, as shown at step 911, coded images for printing are received from a separate computing unit. The coded images may be received directly from separate computing unit, such as a personal computer, cellular phone, PDA etc. or from the local memory, as described above. Subsequently, as shown at step 913, the coded images are being adjusted to the printing process of the cylindrical printer, as described above. Subsequent to step 913 is step 902 in which the curved sheets are conveyed along the non-linear, preferably annular feeding path. In the following step, as shown at 912, the processing unit is used for printing on one of the curved sheets during the conveyance of the curved sheets.

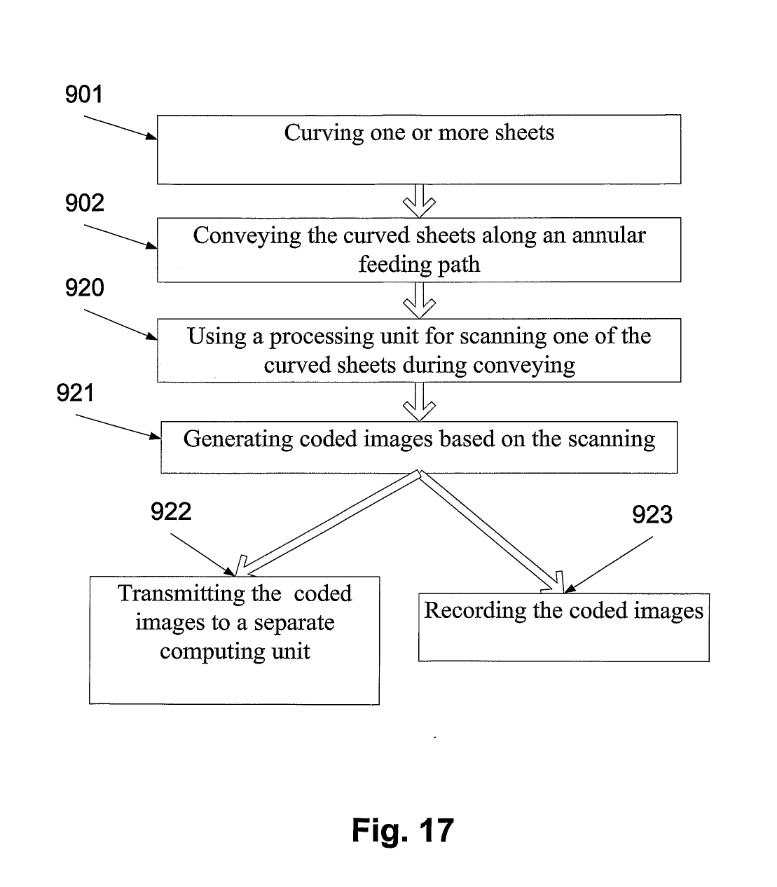

Reference is now made to FIG. 17, which is a flowchart of an exemplary method for scanning according to an embodiment of the present invention. Steps 901-902 are as in FIG. 15 above. However, in FIG. 17, steps 920-923 are added. Subsequent to step 902, as shown at 920, during the conveyance of the curved sheets, the processing unit is used for scanning one of the curved sheets. Then, as shown at step 921, based upon the scanning, one or more coded images are generated. Preferably, as the scan has been performed during the conveyance of the sheets via the non-linear path, the generated coded images may have to be adjusted in order to generate an image that accurately reflects the scanned media. Such an adjustment may be made by the control unit, based upon predefined parameters defined according to the cylindrical printer predefined parameters and calibration. In one embodiment, the generated coded images are recorded on a designated memory of the cylindrical device, as shown at step 923. In another embodiment, as shown at step 922, the coded images are transmitted to a separate computing unit. Preferably, the transmission is forwarded to a computing unit or to a cellular phone which are connected to a facsimile signaling module. Preferably, the transmission is generated using facsimile signaling module and transmitted to a computing unit or to a cellular phone.

It is expected that during the life of this patent many relevant devices and methods will be developed and the scope of the terms herein, particularly of the terms printhead, inkjet, control circuitry, sheet, electric source, and communication interface, are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1-69. (canceled)

70. A processing device for processing at least one curved passing sheet, comprising:
a stationary processing assembly for applying processing to said at least one curved passing sheet, said processing assembly being in a fixed point during said applying, said at least one curved passing sheet being curved around said processing assembly; and
a feed assembly for passing said at least one curved passing sheet by said processing assembly via a non-linear path, along a first vector substantially parallel to a second vector around which said curved passing sheet being curved.

71. The processing device of claim 70, wherein feed assembly is a mechanic transmission configured for conveying said at least one curved passing sheet via a non-linear path in a manner that facilitates the shifting of the entire inner surface area of the said at least one curved passing sheet in front of said processing assembly.

72. The processing device of claim 71, wherein said mechanic transmission comprises at least one of the following group: a gearbox, a set of gears and levers, a set of bands and wheels, an hydraulic system, and a system which is used for transmitting mechanical power from one or more prime movers to a mechanical power output device.

73. The processing device of claim 70, wherein said feed assembly is configured to feed said at least one curved passing sheet in rotary and linear directions about said processing assembly to allow linear processing of said at least one curved passing sheet about said processing assembly.

74. The processing device of claim 70, further comprising:
an internal assembly having an external side; and
an external cylindrical housing having an internal side;
wherein said non-linear path is formed by positioning said internal side relative to said external side of said internal assembly so as to form an annular feeding path therebetween, wherein said external cylindrical housing and said internal assembly are concentric.

75. The processing device of claim 70, wherein said processing assembly comprises a printing module.

76. The processing device of claim 75, wherein said printing module comprises a series of nozzles being configured to spray drops of ink.

77. The processing device of claim 70, wherein said feeding is done in a continuous helical manner.

78. The processing device of claim 70, wherein said processing assembly comprises a scanning module.

79. The processing device of claim 74, wherein said feed assembly comprises a set of gear-wheels for controlling the rotational positioning of said internal assembly during said processing.

80. The processing device of claim 74, wherein said feed assembly comprises:
a first annular set of wheels configured to be coupled to an internal rounded base; and
a second annular set of wheels configured to be coupled to an internal rotating annulus, said internal rotating annulus having an axis of rotation and configured to be concentrically positioned in between said internal rounded base and said external cylindrical housing;
wherein the axes of said first annular set of wheels define a plane which is nearly perpendicularly positioned with respect to said axis of rotation of said internal rotating annulus.

81. A method for processing at least one sheet using a device having an non linear feeding path and a stationary processing unit, comprising the steps of:
a) curving at least one sheet;
b) conveying said at least one sheet in a continuous motion through said non-linear feeding path along a first vector substantially parallel to a second vector around which said at least one sheet being curved; and
c) using said stationary processing unit for processing one of said at least one sheet during said conveying, said stationary processing assembly being in a fixed point during said processing.

82. The method of claim 81, wherein said step (c) comprises using said processing unit for printing on said one of said at least one sheet.

83. The method of claim 82, further comprising a step between step (a) and step (b) of receiving at least one coded image from a separate computing unit, said printing being done according to said at least one coded image.

84. The method of claim 83, wherein said receiving is done using a modem with facsimile signaling.

85. The method of claim 82, wherein said step (c) comprises using said processing unit for scanning said one of said at least one sheet.

86. The method of claim 81, wherein said non-linear path is annular.

87. The method of claim 81, wherein said conveying is done in a helical manner.

88. A processing device for processing at least one curved passing sheet, comprising:
a processing assembly for applying processing to said at least one curved passing sheet;
a feed assembly for passing said at least one curved passing sheet in by said processing assembly via a non-linear path, along a first vector substantially parallel to a second vector around which said curved passing sheet being curved; and a communication interface.

89. The processing device of claim 88, wherein said communication interface is used for receiving at least one transmission image from at least one computing unit, said at least one transmission image comprising at least one coded image, said at least one curved passing sheet being processed by said processing unit according to said at least one coded image.

90. The processing device of claim 88, wherein said communication interface comprises at least one of the following transceivers: a cellular transceiver, a Radio Frequency (RF) transceiver, and an Infrared (IR) transceiver.

91. A processing device for processing at least one passing sheet, comprising:
a stationary processing assembly for applying processing to said at least one passing sheet, said stationary processing assembly being in a fixed point during said processing; and
a feed assembly for passing said at least one passing sheet by said processing assembly, wherein each one of the dimensions of said processing device is smaller than the width and length of said at least one passing sheet.

92. A printer for printing on at least one sheet in a continuous manner, comprising:
a stationary processing assembly for applying processing to a printing area, said printing area having dimensions defined by length and width substantially smaller than the length and width dimensions of said at least one sheet for printing on said at least one sheet, said stationary processing assembly being in a fixed point during said processing; and
a feed assembly for positioning areas of said at least one sheet by said printing area in a continuous unidirectional motion.

93. A printer device for printing on a passing sheet, comprising:
a stationary inkjet printing assembly for applying processing to a printing area, said printing area having dimensions defined by length and width substantially smaller than the length and width dimensions of at least one passing sheet, said stationary processing assembly being in a fixed point during said processing; and
a feed assembly for passing said passing sheet about said printing area using a single motor.
